(19) United States
(12) Patent Application Publication
(10) Pub. No.: US 2009/0099924 A1
(43) Pub. Date: Apr. 16, 2009

(54) SYSTEM AND METHOD FOR CREATING A TEAM SPORT COMMUNITY

(76) Inventors: Ean Lensch, Portland, OR (US); Anthony Abernathy, Beaverton, OR (US)

Correspondence Address: BANNER & WITCOFF, LTD., 1100 13th STREET, N.W., SUITE 1200, WASHINGTON, DC, 20005-4051, US

(21) Appl. No.: 12/240,603

(22) Filed: Sep. 29, 2008

Related U.S. Application Data
(60) Provisional application No. 60/976,288, filed on Sep. 28, 2007.
(60) Provisional application No. 61/013,955, filed on Dec. 14, 2007.

(51) Int. Cl. G06Q 30/00; G06Q 10/00; G06Q 90/00

(52) U.S. Cl. 705/14; 705/26; 705/1

(57) ABSTRACT

Systems and methods are disclosed for creating a team sport community including organizing a sporting event for a team sport. More specifically, a team sport may be selected from a plurality of team sports and a team having a plurality of positions may be assembled to participate in the team sporting event. One or more players may be associated with each position on the team. Each player may have a player profile that describes player information such as a player's name, games scheduled for the player, and the player's statistics. A player may create a sporting event for a team and may also search for a sporting event in which to play as an individual player or as a position on a team. A player may also search for a sporting event by the location of the sporting event and obtain information about the location, time, teams, and players associated with the sporting event.

### RELATED APPLICATIONS

This application claims the benefit of U.S. Provisional Patent Application No. 60/976,288, filed on Sep. 28, 2007 and U.S. Provisional Patent Application No. 61/013,955, filed on Dec. 14, 2007. Each of these patent applications is entirely incorporated herein by reference.

### FIELD OF THE INVENTION

Aspects of the disclosure relate to creating a team sport community. More specifically, aspects of the disclosure provide a networking community for players and teams interested in communicating with one another about a team sport and team sporting events.

### BACKGROUND

Many individual players, groups of players, and teams share a common interest in a team sport such as soccer/football, American football, basketball, baseball, volleyball, softball, rugby, lacrosse, hockey, and the like. Oftentimes, players and teams find great difficulty in communicating about their interests and sharing information, experience, games, events, videos, and the like. Players and teams communicate about their common team sports-related interests over the telephone, electronic mail (e-mail), short message service (SMS), social networking communities, and the like. The communication process is time-consuming, cumbersome, and burdensome and results in frustration about the communication resulting in decreased interest in participating in the team sport.

In many team sports, players organize a team and a game by calling each other and/or sending an email, text message, short message service, or other electronic message to indicate the date, time and location for a game. Many games are difficult to organize and may never materialize as a result of the high quantity of messages that are required to schedule the game. Further, a player may want to communicate a message to a group of players by calling, emailing, and/or text messaging each player, which is also time-consuming and difficult to organize. A player who is unable to participate in a game may provide the team with short notice of the cancellation and the entire game may need to be canceled because the team cannot find a replacement player.

Additionally, many individual players search for a team on which to play and many teams search for players to fill positions on their team. Players miss opportunities to play in a game or with a desired team because they were unaware of the opportunity. Teams miss games because they do not have enough players and because of poor communication and organization. The communication and organization that is required to match players with teams is thus very time-consuming and cumbersome.

While certain systems according to the prior art have been provided to assist in communication among players and teams, such systems still have disadvantages as discussed. A team sport community is needed that creates a network of players and teams that may communicate quickly and efficiently so that participation is increased and more games are played. Further, a team sport community is needed that provides players and teams with current information about a team sport, team sporting events, players, and games. Accordingly, the present invention is provided to solve certain of the drawbacks of the prior art and to provide advantages not heretofore available.

### BRIEF SUMMARY OF THE INVENTION

The present invention provides a system and method for creating a team sport community. Aspects of the present disclosure address one or more of the issues mentioned above by describing a system and method for organizing a team sporting event. The following presents a simplified summary of the disclosure in order to provide a basic understanding of some aspects of the systems and methods of organizing a team sporting event. It is not intended to identify key or critical elements of the invention nor is it intended to delineate the scope of the invention. The following summary merely presents some concepts of the disclosure in a simplified form as a prelude to the more detailed description provided below.

In one example in accordance with aspects of the disclosure, a social network for sporting activities comprises: (a) a memory having a plurality of modules; (b) a computer interface for receiving a first input relating to a first sporting activity; (c) a processor for configured to evaluate the first input based at least in part on the information stored in at least one of the user profile module, the sporting activities module, and/or the messaging module; and an output device for outputting the at least one characteristic of the sporting activity. The plurality of modules may include a user profile module for storing user profile information including at least a first user profile and a second user profile; a sporting activities module for storing information relating to at least one sporting activity; and messaging module storing information relating to messages from the first user profile and/or the second user profile.

In another aspect of the invention, a computer-readable medium comprises computer-executable instructions that perform a method comprising the steps of: (a) identifying a sporting activity; (b) identifying a venue of the sporting activity; (c) identifying a first team to participate in the sporting activity, the first team comprising a plurality of first positions; (d) associating at least a first player with at least one of the first positions; (e) identifying a second team to participate in the sporting activity, the second team comprising a plurality of second positions; and (f) associating at least a second player with at least one of the second positions for the second team; (g) scheduling the sporting activity; and (h) sending a message containing information about the sporting activity to the first player and the second player.

In yet another aspect of the invention, a method of organizing a team sporting event, comprising: (a) identifying a sporting activity; (b) identifying a venue of the sporting activity; (c) identifying a first team to participate in the sporting activity, the first team comprising a plurality of first positions; (d) associating at least a first player with at least one of the first positions; (e) identifying a second team to participate in the sporting activity, the second team comprising a plurality of second positions; (f) associating at least a second player with at least one of the second positions for the second team; (g) scheduling the sporting activity; and (h) sending a message containing information about the sporting activity to the first player and the second player.

The first and the second player may be capable of filling more than one position for a team. A position on a team may correspond to a defined group of skills and/or tasks for a player on a team. For example, a forward is typically responsible for scoring goats and are often expected to aid, the mid-fielders and defense to begin an offense action against the other team. In another example, a goalie may be responsible for preventing the opposing teams from scoring, e.g., directing the football into the goal. The goalie may be permitted to use his hands within a penalty box that is typically defined by a visible line on the field and may be the only player on the field that is permitted to touch the football with his hands.

### BRIEF DESCRIPTION OF THE DRAWINGS

A more complete understanding of the present invention and certain advantages thereof may be acquired by referring to the following description along with the accompanying drawings, in which like reference numbers indicate like features, and wherein:

FIG. 1 illustrates a computing system for implementing an embodiment of the invention.

FIG. 2 is a flowchart of a method for organizing a team sporting event, according to an aspect of the invention.

FIG. 3 is a flowchart of a method for selecting a player for a team sporting event, in accordance with an aspect of the invention.

FIG. 4 is a home page, in accordance with an aspect of the invention.

FIG. 5 illustrates another example of a home page, according to an aspect of the invention.

FIG. 6 illustrates a web page that includes venue information for a team, in accordance with an aspect of the invention.

FIG. 7 illustrates a web page for a registered team to challenge another team, according to an aspect of the invention.

FIG. 8 illustrates a web page for creating a game, in accordance with an aspect of the invention.

FIG. 9 illustrates another web page for creating a game, according to an aspect of the invention.

FIG. 10 illustrates calendar page for showing the games that are scheduled for a player, according to an aspect of the invention.

FIG. 11 is a recurring game for a player profile, according to an aspect of the invention.

FIG. 12 illustrates a web page to invite players to participate in a game, according to an aspect of the invention.

FIG. 13 is a web page illustrating a map that depicts the location of a game, in accordance with an aspect of the invention.

FIG. 14 illustrates a web page for a team profile, according to an aspect of the invention.

FIG. 15 illustrates a player profile page, according to an aspect of the invention.

FIG. 16 illustrates web page for a player profile to create a new game, in accordance with an aspect of the invention.

FIG. 17 is another example of a player profile page illustrating a game in which the player profile is scheduled to participate, according to an aspect of the invention.

FIG. 18 is another example of a feature for a player profile page for selecting a venue for a game, in accordance with an aspect of the invention.

FIG. 19 is yet another example of feature for a player profile page for illustrating a player's statistics, according to an aspect of the invention.

FIG. 20 illustrates another example of a feature for a player profile page that includes a search for other players and teams, in accordance with an aspect of the invention.

FIG. 21 illustrates a web page for awarding a player currency, according to an aspect of the invention.

FIG. 22 is a web page for displaying post-game information relating to a game, in accordance with an aspect of the invention.

FIG. 23 illustrates a web page for providing a communication forum for players and teams, according to an aspect of the invention.

FIG. 24 illustrates a web page for providing information about a venue or location, in accordance with an aspect of the invention.

FIG. 25 illustrates a web page for creating a tournament, according to an aspect of the invention.

FIG. 26 illustrates a web page for providing information about training sessions, accordingly to an aspect of the invention.

FIG. 27 illustrates another example of a web page for providing information about a training session and for providing a map to indicate the location of the training session, according to an aspect of the invention.

FIGS. 28-36 illustrate another embodiment of a system according to aspects of the invention that relate to a team sport community for basketball.

FIG. 28 illustrates another example home page, according to aspects of the invention.

FIG. 29 illustrates a web page for creating a new game in accordance with aspects of the invention.

FIG. 30 illustrates a web page displaying information relating to upcoming games, according to an aspect of the invention.

FIG. 31 illustrates a web page with information finding games that may be played, according to aspects of the invention.

FIG. 32 illustrates a web page with information relating to the courts on which the games may be played and an option to add a court or location to the available courts, in accordance with an aspect of the invention.

FIG. 33 illustrates a web page for archiving games and providing information on players and games, according to an aspect of the invention.

FIG. 34 illustrates a web page that has information relating to a venue, in accordance with aspects of the invention.

FIG. 35 illustrates a web page that has archive information relating to games, according to aspects of the invention.

FIG. 36 illustrates a web page that has information relating to player ratings, according to aspects of the invention.

### DETAILED DESCRIPTION

In the following description of various example embodiments of the invention, reference is made to the accompanying drawings, which form a part hereof, and in which are shown by way of illustration various example devices, systems, and environments in which aspects of the invention may be practiced. Other specific arrangements of parts, example devices, systems, and environments may be utilized and structural and functional modifications may be made without departing from the scope of the present invention.

### I. General Description of Creating a Team Sport Community According to Aspects of the Invention

In general, as described above, aspects of the invention relate to a teams sports community for players, teams, and others involved in team sports. In accordance with at least some aspects, the creation of a team sports community may include: (a) identifying a group of users that are interested in a team sport; (b) creating a community that includes a plurality of options, the community being created for the users by linking the users together based on a plurality of criteria; and (c) identifying a forum on which multiple users may communicate.

A group of users may access the systems and methods of the present invention associated with team sports. The group of users may be an individual player, a group of players, a team, a manufacturer of sporting equipment, a fan, a coach, and the like. The user may be any entity that wishes to access information about the team sporting event. The user may wish to obtain information about the sport, the players, the teams, the rules of the team sports, and other related topics. The user may also wish to search for information about fan clubs, training sessions, group events, fundraisers, competitions, or simply learn about the team sporting community and any other characteristic that is provided by the team sporting community.

A community for the users may be created that includes team sports such as soccer/football, American football, basketball, baseball, volleyball, softball, rugby, lacrosse, hockey, tennis, and the like. The community may include a plurality of options for teams, players, fans, coaches, managers, and other users that may wish to participate in the team sporting community. The plurality of options may include obtaining general information about the team sport, the team, and individual players, coaches, and fans. The community may be communicate through a network, such as a computer network, a mobile phone network, the public switched telephone network (PSTN), and may be wired or wireless.

The community may also communicate over more than one type of network. For example, the community may communicate over the mobile telephone network and the Internet. A user may have a mobile computing device having access to both the mobile telephone network and the Internet. The mobile computing device may be a mobile telephone, a smart phone, a device enable with voice over Internet Protocol (VoIP) capabilities, or any other computing device that may access the mobile telephone network. The user may access the sporting community that is maintained on a website stored on a web server. In one aspect, the user may download a software application to the mobile computing device having a wireless (Wi-Fi) Internet transceiver. The software application may permit the user to directly communicate with the sporting community website. In another aspect, the user may communicate with the sporting community website by communicating over both the mobile telephone network and the Internet.

The users may communicate by an electronic network or a manual network. A manual network may be operated and maintained by a user or group of users. An electronic network may be operated and maintained by a computing device and may be configured to automatically generate messages to users, post information about the team sport, training sessions, games, players, and teams, after it is updated in the computing device. In an embodiment, the manual network may also be a traditional telephone tree list in which a first user is assigned to call a second user to communicate a message and the second user is assigned to call a third user to communicate the message. In such a manual network, the message may be communicated by a variety of media including, but not limited to a telephone call, a letter, a text message or other SMS, an e-mail, web log posting, social network communication, webpage update, and/or a physical and/or virtual bulletin board.

In another embodiment, at least a portion of the communication between the users is automatically generated based on an input to the sporting community. For example, an input may be received by the sporting community and a processor (explained in greater detail below) may evaluate the input and automatically take an action within the sporting community. The action may be searching for a sporting activity, a team, a player, a venue, sporting rules, bulletins, prizes, merchandise, statistics, articles, news, scores, and/or any other information relating to the sporting community.

The sporting community may include a plurality of user options such as creating and/or organizing a team sport event, searching for a player, group of players, a team, and/or team sports event, booking a venue for a team sport event, tracking results of team sports events, viewing statistics about a team, player, group of players, or the like, viewing standings of teams and players, rating players and teams, earning prizes, gifts, and other awards.

The team sport event may be organized by a user such as a player or team selecting a date, time, location, and other logistical details for a sport event. The user may also select a player or group of players for the team. The user may send an invitation or other communication to inform the player that he or she has been selected or invited to play on the team. After the sport event is organized, it may be displayed on a calendar or other list of upcoming sporting events. The calendar or other list of sporting events may be filtered to illustrate an individual users' schedule, such as filtering by a team or an individual player. A player and/or team may permit other users to view its calendar to assist in scheduling teams and players for a sporting event.

For example, a first team may wish to invite a second team as an opponent in a game on a Monday night at 7 o'clock. The second team may already have a game scheduled for that time and may display its schedule of upcoming games on a calendar that is accessible to other teams, players, and/or users. The first team may refrain from inviting the second team to play in the Monday game because the second team's calendar displays a conflicting game.

A response to an invite may be sent to the organizer of a game. Further, a request may be sent to the organizer from a player or team that has not been invited. Messages may also be sent to the organizer of a game as it is in the process of being scheduled. The schedule related to the game may also display the players and/or teams that have confirmed their attendance at the game, declined to attend the game, have not responded about the game, and/or remain undecided about whether to attend the game.

A map may be associated with a game that illustrates the games physical location and provides information about the venue such as the name of the venue, a physical map of the venue, a map of the streets near the venue, a telephone number and address of the venue, and the like. The map may also permit a user to request driving directions to the venue.

The map may permit a user to request that a game be scheduled for a particular venue, sometimes referred to as a pitch, court, field, or other athletic facility. For example, a map may display a venue and a schedule of available time periods in which a team and/or player may schedule a game. A player may select a venue and request to create a game at the venue. The player may post a new game and the players that may be requested to attend. The player may also send invitations to one or more players to participate on the team or in the game. The player may also post the game on a bulletin board and solicit other players to request to participate in the game.

A recurring game may be created and/or a series of games may be created. For example, a season may be created for a team sport that includes a plurality of games. The season may include a plurality of teams that participate in a league and each play the other teams one or more on one or more occasions.

A tournament may also be created for a sporting event. The tournament may include a group of teams that each play a series of games against one another. The winner of the tournament may be given a prize or other award.

Additionally, a team profile may be created that includes information about players on a team and general information about the team. The team profile may include the type of team sport or sports that the team plays, the level at which the team competes, the captain or manager of the team, team statistics, information about the players, game schedule, and other team related information. The team profile may also include a video and/or picture of the team and may also include testimonials about the team from players, coaches, positions, former positions, fans, and the like.

An individual currency and recognition may be established for a player, team, and other users to track wins, losses, goals and other game statistics, attendance, and the like. The individual currency may represent at least a portion of a player and/or team rating that indicates a player's and/or team's quality, diligence in attending games, integrity, and the like. A player and/or team may earn individual currency by completing positive actions and displaying positive behavior and may lose individual currency by completing negative actions and displaying negative behavior.

For example, a team may win a game against a good team and earn individual currency for the positive behavior. The same team may also have accumulated multiple penalties for unsportsmanlike conduct during the game and may lose individual currency for the negative actions.

In another example, an individual player may earn individual currency for being awarded a “player of the game” award, achieving a perfect attendance award, and the like. The player may lose individual currency if the player fails to attend a game that the player was committed to attending, committing several mistakes during a game, being assessed a penalty or penalties for negative behavior during a game, and any other negative action and/or behavior.

The individual currency provides a forum on which the players and teams may self-regulate and monitor the behavior of other players and teams. The individual currency creates accountability of the players and teams to one another and helps to promote the team sporting community in addition to individual promotion.

In some embodiments, prizes and/or awards may be earned or awarded based on individual currency, contests, tournaments, and the like. The awards may include honoring a player or group of players for their contribution to the team, such as a completing a good offense or defense play.

A team, player, or other user may provide feedback to the team, player, venue, and/or other entity related to the team sport. For example, a first player may provide a second player with feedback after a game regarding the quality of the first player's skills in the team sport. Additionally, a player, group of players, team, or other related users may engage in communication about a game before it occurs, in a type of “bantering” style, such as predicting the outcome of the game.

Another example of the features associated with organizing a team sport community includes providing the ability to couple the team sport community and a social network. The team sport community may be coupled to the social network in a manual fashion such as a telephone tree, as described above. The team sport community may also be coupled to the social network in an electronic fashion, such as through a computer network like the Internet. An electronic social network may integrate the team sport community within an existing network of users.

### II. Specific Examples of the Invention

The organization of a sporting event relates to the selection of a team sport, identification of a team and a plurality of players associated with the team, and the association of at least two teams with the sporting event. Each sporting event may be organized based on a team including a plurality of positions for the team sport that is selected. A player may be associated with each position and each player may have a player profile that includes at least a name of the player.

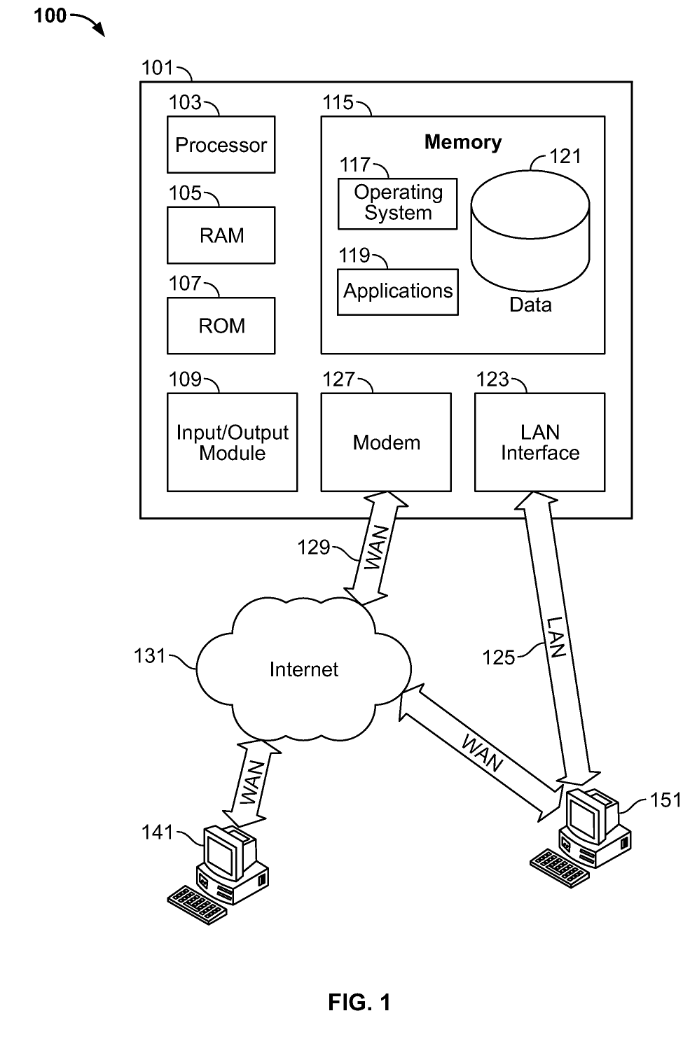

FIG. 1 illustrates an example of a computing system environment 100 that may be used according to one or more embodiments of the invention. The computing system environment 100 is only one example of a suitable computing environment and is not intended to suggest any limitation as to the scope of use or functionality of the invention. The computing system environment 100 should not be interpreted as having any dependency or requirement relating to any one or combination of the illustrated components.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, smart phones, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, an input/output module or BIOS 109, and a memory 115. The computer 101 typically includes a variety of computer readable media. The computer readable media may be any available media that may be accessed by the computer 101 and may include both volatile and nonvolatile media and removable and non-removable media. By way of example, and not limitation, computer readable media may comprise computer storage media and communication media.

Computer storage media may include volatile and nonvolatile and removable and non-removable media implemented in any method or technology for storage of information such as computer readable instructions, data structures, program modules, or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, and any other medium that can be used to store the desired information and that can be accessed by the computer 101.

Communication media may embody computer readable instructions, data structures, program modules, and/or other data in a modulated data signal such as a carrier wave or other transport mechanism. It may also include any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Although not shown, RAM 105 may include one or more applications representing the application data stored in RAM 105 while the computer is on and corresponding software applications (e.g., software tasks) are being executed.

The input/output module or BIOS 109 may include a microphone, keypad, touch screen, and/or stylus through which a user of the computer 101 may provide input. The input/output module or BIOS 109 may also include one or more of a speaker for providing audio output and a video display device for providing textual, audiovisual, and/or graphical output.

Software may be stored within memory 115 and/or storage to provide instructions to the processor 103 for enabling the computer 101 to perform various functions. For example, the memory 115 may store software used by the computer 101, such as an operating system 117 and an associated data file 121. Alternatively, some or all of the computer executable instructions for the computer 101 may be embodied in hardware or firmware (not shown). As described in detail below, the data file 121 may provide centralized storage of the organization of the sporting events and/or selection of a player for a team sport.

The computer 101 may operate in a networked environment that supports connections to one or more remote computers, such as computing devices 141 and 151. The computing devices 141 and 151 may be personal computers or servers that include many or all of the elements described above relative to the computer 101. The network connections depicted in FIG. 1 may include a local area network (LAN) 125 and a wide area network (WAN) 129 and may also include other networks. The computer 101 is connected to the LAN 125 through a network interface or adapter 123. The computer 101 may be a server and may include a modem 127 or other means for establishing communications over the WAN 129. For example, the computer 101 may connect to a WAN 129 such as the Internet 131 through a modem connection. The network connections may include any communications link between computers.

The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program may be used by the computer 101 according to an embodiment of the invention. The application program may include computer executable instructions for invoking user functionality related to communication, such as email, short message service (SMS), and voice input and speech recognition applications.

The computing devices 141 or 151 may also be mobile terminals including various other components, such as a battery, speaker, and antennas (not shown). The input/output module or BIOS 109 may include a user interface including such physical components as a voice interface, one or more arrow keys, joystick, data glove, mouse, roller ball, touch screen, keypads or the like.

Each of the plurality of computing devices 141, 151 may contain software for creating a data file 121. The software may be a set of detailed computer-executable instructions for the computing devices 141, 151. The software may provide the computing devices 141, 151 with the ability to create a data file 121. The data file 121 may contain multiple individual files of information that may each correspond to an individual document.

For example, a plurality of players may each have a player profile and each player profile may be separately contained within the data file 121. Similarly, information about a plurality of sporting events and a plurality of teams may be separately contained within a data file 121 and may be separately contained from the player profile information. Additionally, a report may be generated that includes information relating to one or more sporting events, players, and/or teams in the data file 121.

The computer 101 may include memory 115 for storing computer-readable instructions and a processor 103 for executing the computer-executable instructions. The computer-executable instructions may be data in the form of program source code that may be capable of modifying the data file 121. The computer-executable instructions may be a series or sequence of instructions for a computing device that is typically in the form of a programming language such as C++, Java, SQL, or the like. Various computer programming languages may be used to create the computer-executable instructions, and the invention is not limited to the programming languages listed above.

The memory 115 may be a portion of the computer 101 that stores data or other instructions. The memory 115 may be retained or lost when power is lost to the system. The memory 115 may provide access to data for a user or computing device 141, 151 to revise and manage a data file 121.

The processor 103 may be capable of executing the computer-executable instructions. The computer-executable instructions may be executed by the processor 103 after they have been stored in the memory 115. The processor 103 may be a centralized element within a computing system that is capable of performing computations. For example, the processor 103 may perform the computations that are described in the computer-executable instructions and then execute the computer-executable instructions. The computer-executable instructions may include data describing changes to the data file 121 that were made by a user or computing device 141, 151 over a computer network such as the Internet 131. The server 101 stores the data in the data file 121 that may be associated with a player or team. The data file 121 may be stored in the memory 115 so that it may be accessible to a plurality of computing devices 141, 151 and/or users.

The data that is stored in the data file 121 may include information about organizing a team sport, a player, a team, a location of a team sporting event, a training camp, and the like. The date file 121 may store any desired information, relating to organizing a team sporting event.

The information for organizing a team sporting event may be stored in the data file 121. Security precautions may be implemented to prevent unauthorized access to the data file 121. A username and a password may be required to access the data file 121. Some of the data that is stored in the data file 121 may be shared between multiple players, teams, organizers of team sporting events, and the like. Any desirable security precautions may be implemented.

The computer-executable instructions may be a series or sequence of instructions for a computing device 141, 151, described in detail throughout this disclosure. The processor 103 may be configured to execute the computer-executable instructions that may be used to organize a team sporting event. Such computer-executable instructions may be located (e.g., physically or logically) in modules in the memory 115. The computer network 131 may be any network that interconnects users and/or computing devices 141, 151. According to at least one aspect of the invention, the computer network 131 may provide shared access by two computing devices to at least a portion of the data in the plurality of modules. Shared access may be two or more computing devices 141, 151 that may be coupled to the computer network 131 and/or that may be able to communicate with each other and/or access, change, and add data to a data file 121.

A computer network such as the Internet 131 provides access to the date file 121 that may be shared between the computing devices 141, 151. Additionally, the computer network may be public or private and may be wired or wireless. The computing devices 141, 151 that are coupled to the computer network may be any electronic device that is capable of connecting to a computer network and transmitting data over the computer network. Further, the computing devices 141,151 are capable of receiving data for entry into a data file 121 that may be associated with organizing a team sporting event.

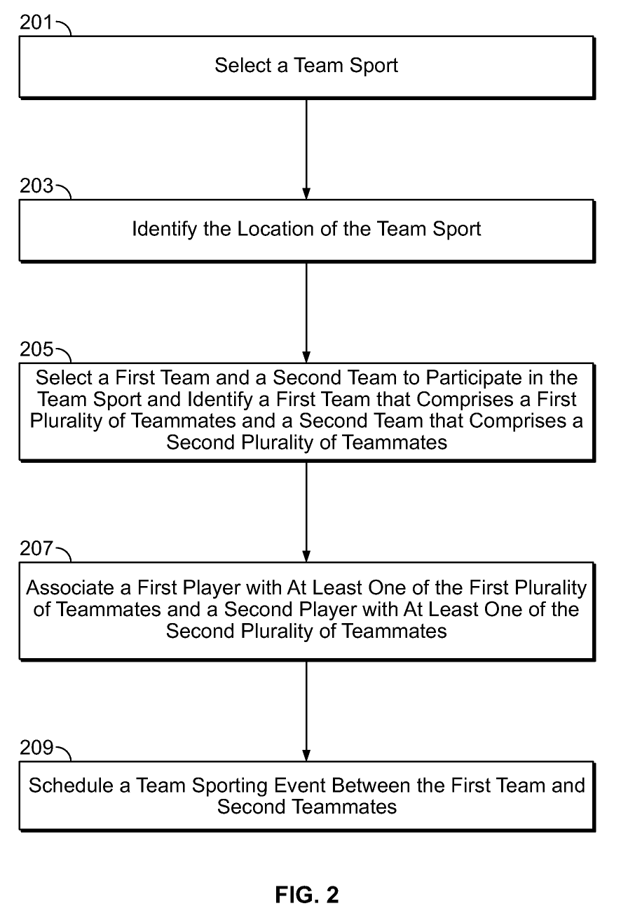

In reference to FIG. 2, a method of organizing a team sporting event is illustrated. At step 201, a team sport is selected. A location of the team sport may be identified at step 203. A first team and a second team are selected to participate in the team sporting event. The first team comprises a first plurality of positions and a second team comprises a second plurality of positions, at step 205. A first player may be associated with at least one of the first plurality of positions and a second player may be associated with at least one of the second plurality of positions, at step 207. A team sporting event may be scheduled between the first team and the second team, as illustrated in step 209.

As illustrated in step 201, a team sport may be selected. The team sport may be any desired team sport and includes, but is not limited to, soccer/football, basketball, American football, baseball, volleyball, softball, rugby, lacrosse, and hockey. The team sport may be a competition that is a sporting event in a sports league, a professional league, an intramural league, a children's league, an adult league, a women's league, a men's league, a co-educational league, and the like. The team sport may be any desired team sport and the players on the team may include any desired demographic.

Step 203 illustrates that the location of the team sport may be identified. The location may be an indoor or outdoor venue, arena, field or pitch, a gymnasium, a park, a school, or any other desired location. The location may be identified by the type of team sport that will be a played at the team sporting event, the time of the team sporting event, the time of the team sporting event, the age group for a team sporting event, the gender group for a team sporting event, and/or any other distinguishing characteristic.

A first team comprising a first plurality of players may be selected and a second team comprising a second plurality of players may be selected at step 205. In many team sports, at least two teams participate in the competition of a sporting event. In some instances, such as a tournament style competition, more than two teams participate in the sporting event.

Each team comprises a plurality of positions that may be played by one or more players. The positions typically represent the players that may be needed to field a complete team or at least a competitive team for the team sport or a particular game. For example, a soccer/football team may comprise a certain number of players in which five players play in the game at one time. Thus, in one exemplary embodiment, the team sport is soccer/football consisting of 5 players on one team competing against five players on another team. Some rules may permit a team to compete in a soccer/football game if there are other numbers of players on the team.

The positions may represent the total number of players on each team. The total number of players may include one or more players for each teammate on the team. Each position may correspond to a position on the team. For example, a soccer/football team may have two players that are capable of playing the position of goalie. Many teams have more than one player that is capable of playing a specific position to provide each player with a resting period or replacement player during the game.

At step 207, a first player may be associated with at least one of the first plurality of positions and a second player may be associated with at least one of a second plurality of positions. Each of the first player and the second player may be capable of playing at least one of the positions on the team. For example, a first player may be capable of playing a position of goalie or goalkeeper in a soccer/football game. A second player may be capable of playing a forward and a back position in the same soccer/football game.

Step 209 illustrates scheduling a team sporting event between the first team and the second team. The team sporting event may include two or more teams. The schedule of the team sporting event may include selecting a time, a location, a field/pitch, and the like. The schedule may be configured to be an invitation to a team or group of teams that may be invited to participate in the team sporting event. The schedule may also be posted on a website or other posting that informs the teams of the schedule of the team sporting event. The player may choose to post this invitation on a public website or send a private invitation to another team or group of teams.

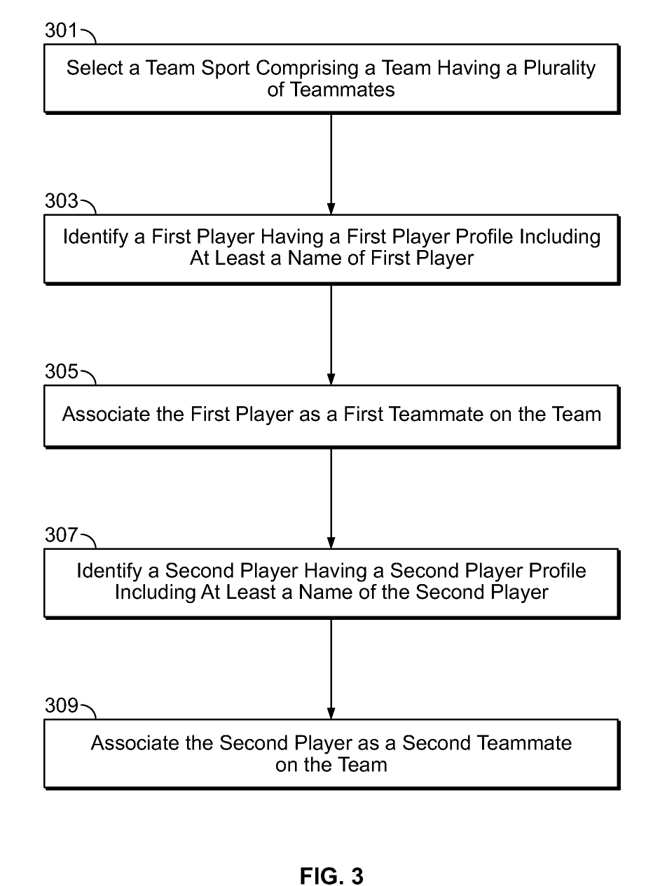

A method of selecting players for a team is illustrated in reference to FIG. 3. At step 301, a team sport comprising a team having a plurality of positions is selected. A first player having a first player profile that includes at least a name of a first player is identified at step 303. The first player is associated as a first position on the team at step 305. A second player having a second player profile that includes at least a name of the second player may be identified, at step 307. The second player may be associated as a second position on the team at step 309.

The player may be permitted to revise information on the web page or may only be permitted to view and read the information on the web page. For example, a team's manager or coach may be permitted to revise the team profile whereas individual players on the team may only be able to view the team profile. In another example, a team or player may be permitted to filter a posting on their team profile or player profile, respectively. If first team or player wishes to publicly display a message about a second team or player, the message may be monitored and filtered by the second team before it is permitted to post the team's or player's profile.

Step 301 illustrates that a team sport comprising a team having a plurality of positions may be selected. The team sport may be any desired sport that includes a group of players, as described in detail above. The team may comprise the group of players and the positions may indicate the positions that are required to field a team. The number and positions of the positions may or may not correspond to a maximum limit of the number and positions of players that may be permitted to play during the team sporting event. For example, a team may be permitted to play in the team sporting event with fewer than the maximum number of permitted players.

As illustrated in step 303, a first player having a first player profile that includes at least a name of the first player may be identified. The first player may be any player that is capable of playing the position that is associated with the first position, as illustrated in step 305. The first player may be associated with more than one position, and hence more than one position, depending on the needs of the team and the experience of the first player.

The name of the first player may be the player's first name, family name, nickname, or any other desired name. The first player profile may include information about the player's statistics, experience, team affiliations, attendance, rankings, peer-ratings, positions on the team sport that the player is capable of playing, and the like.

Similar to the relationship described above for the first player in step 305, a second player having a second player profile that includes at least a name of the second player may be identified at step 307. The second player may be any player that is capable of playing the position that is associated with the second position, as illustrated in step 309, and may be associated with more than one position and/or position on the team.

### Organizing a Game Between Two Teams

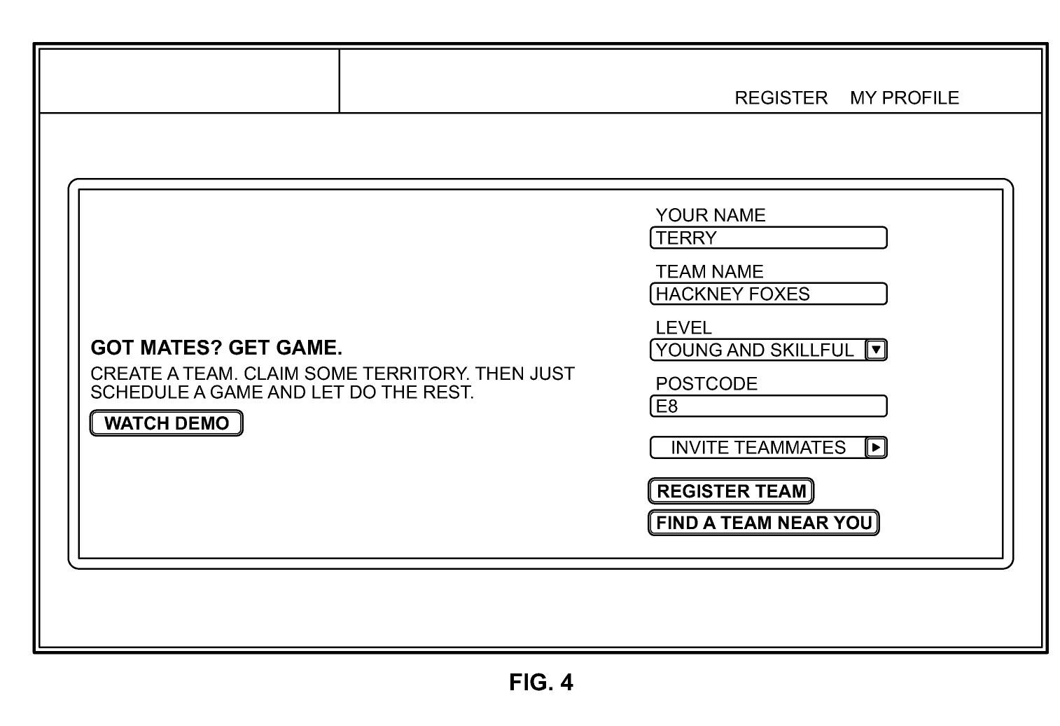

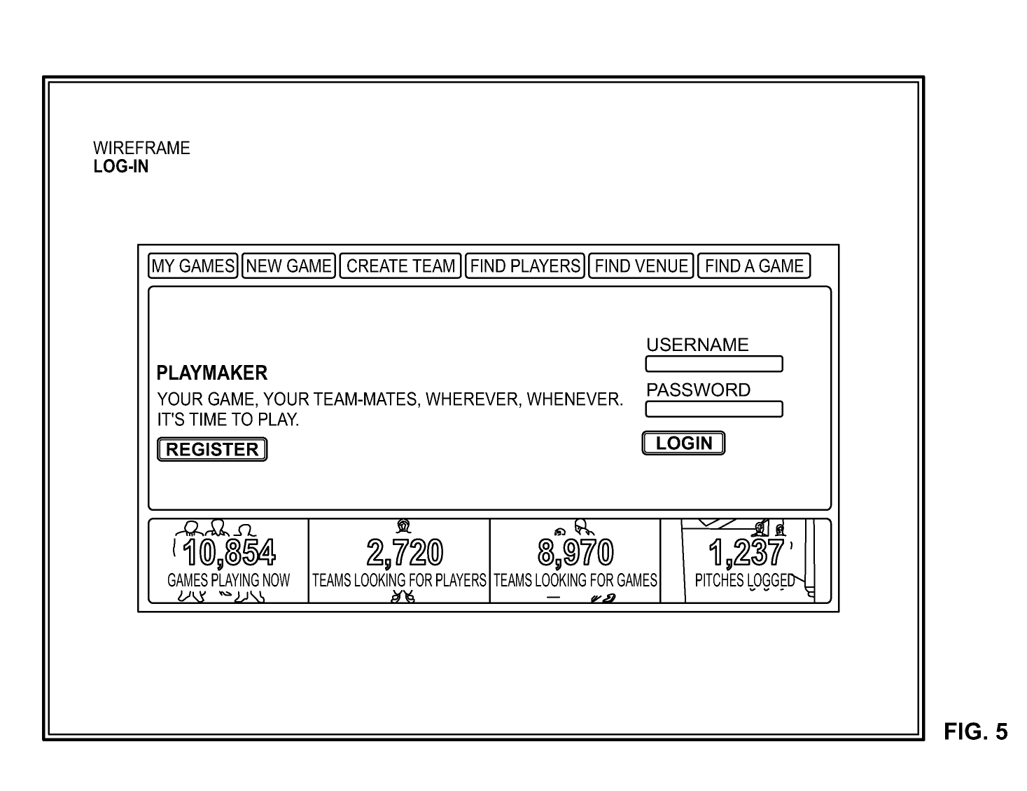

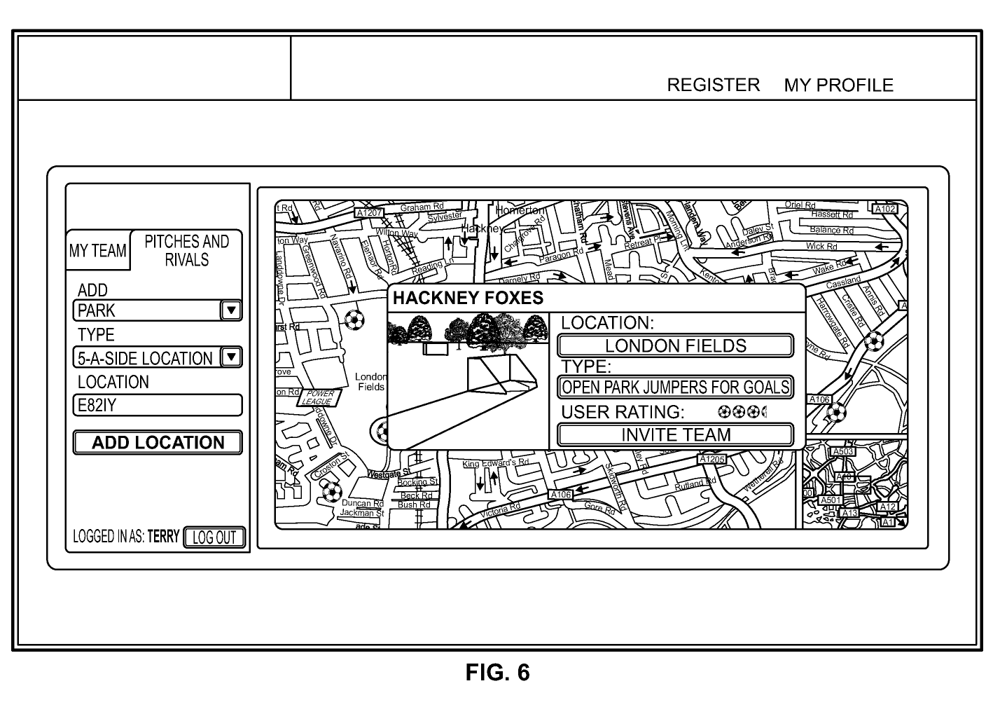

As discussed, the systems and methods of the present invention can be utilized in a computer system such as shown in FIG. 1. A series a web pages may be associated with the system and hosted by the computer system. The series of web pages may permit a game to be organized between two or more teams. A player and/or team may organize a game. The player and/or team may also organize a recurring game or tournament, as described below. For example, a team organizer or representative such as a coach or manager can create username and password at the home page of FIGS. 4 and 5 and proceed to register the team. FIGS. 6-9 disclose additional web pages provided by the system for a team to register and begin scheduling games with other teams.

As illustrated in FIG. 4, a home page may be associated with the computer 101 and accessible by other devices such as computing devices 141, 151. The home page may include a link for a player or team to register, a link to a player or team's profile, and other general information about a team sport. A player may search for a game by a plurality of criteria such as a player name, a team name, a level of play, a geographic region, and the like. A player may send an invitation to another player to join a game from the home page based on the search criteria. The home page may also include a video clip, such as a demonstration video for a team or player, as illustrated in FIG. 4. The home page may include any desired information.

The home page may also include a group of options for a user including, but not limited to, accessing a secure area of a website by providing a security code, e.g., a username and password, performing a search for a team, team sporting event, player position, skill level, gender of the team, location of the team sporting event, and the like, registering a user as a player having a player profile, and registering a team having a team profile. The home page may also include information about the team sport or sports, training events, promotional events, instructions and rules about the team sport, the organization that maintains the website, the league or leagues in which the team sports are organized, and other similar information. The home page may include any desired information relating to organizing a team sporting event.

Another example of a home page is illustrated in FIG. 5. The home page may include information about the current games that are in progress, the teams that are looking for players to participate in a team sporting event, the teams that are searching for a game, and the locations at which the sporting events may be located. The home page may also provide a player or team with a player profile or team profile, respectively. For example, a player may register a player profile. The player may also associate security information, such as a username and password, with providing access to the player profile. The player may input the username and password and be permitted access to a player profile, as illustrated in FIG. 5.

The home page may also include an option to search for the games that are associated with a player or team. The home page may include an option to create a new game for a player and/or team. A player may be permitted to create a team and a player and/or team may be permitted an option to find players for the team, find a location or venue for a team sporting event, and/or find a game for a team and/or player. The home page may further include information about the number of games being currently played, the number of teams that are searching for a player for a game, the number of teams looking for games, and other desired information.

The home page may include a link to a “my games” web page. The my games web page may include information about a player's or teams games that are scheduled. The my games web page may also include information about games to which the player or team is invited or have invited other players or teams. The my games page may be displayed in many forms, including, but not limited to, calendar that depicts the games to which the player and/or team is committed for a future game, games to which the player and/or team is invited, tentatively scheduled games, tournaments, training sessions, practice games, competitions, and other games or commitments.

The home page may also include a link to a “new game” web page. The new game web page may include a request to create a new game by a player and/or team. The new game web page may include information about creating a new game such as establishing a date, time, and location of a game and may include information about the players and/or teams that are invited to participate in the new game or may invite teams and/or players to participate in the new game.

The home page may also include a link to “create a team” web page. A player or team may create a team by designating a player or group of players to play on the team. A team may include players that are capable of playing more than one position and may include more than one player that is capable of playing a specified position, such as a “back-up,” “alternate,” or “second string” player.

The home page may include a link to “find players” for a game. A player and/or team may have scheduled a game and may need or want additional players to play in the game. In this example, the player and/or team may search for available players by sending invitations to selected players, posting the invitation to play in the game to a group of players, and the like. The find players web page may be designed to search for players as a substitute or last minute addition to a team.

The home page may include a link to a web page that searches for a venue at which a game is being played. A player may live or work near a particular venue or location and may wish to join a game at that particular location. The home page may also include a link to a web page that permits a player to search for a game in which to play. For example, the player may wish to play in a game on a Thursday evening between 7 o'clock and 9 o'clock. The player may search for teams that are in need of a player to play in a game that begins between 7 o'clock and 9 o'clock on Thursday evening.

FIGS. 6-9 illustrates a player profile for a player named Terry. Terry may create a player profile and may be search for a game in which to play, create a game, search for a team on which to play, establish a venue, search venues, and the like. FIG. 6 shows a web page that includes team information for a team named the Hackney Foxes, which may generally be referred to as a first team. The team information can include the team name, team manager, roster of players, team and player statistics, and the like.

Terry may register the team and may find a team to challenge, schedule a game, and send invites to participate in a game. In FIG. 6, a map is illustrated having five games scheduled. Each game may be indicated by an icon of a soccer ball/football. Terry may select to view the game scheduled at a location, such as the game scheduled at London Fields. A map may illustrate the scheduled games at that location and may indicate recurring games or a tournament at a particular location. The map may also describe details about the location and/or venue's characteristics such as what type of team sport may be played at the location or venue, the equipment that may be available at the location and/or venue, whether the venue and/or location is an indoor or outdoor arena, and the like.

A team may add a location and may indicate that a game is scheduled for a particular location. A team may choose to add a location as an available venue for a game. The team may add a location by entering the name of the location, the type of location, e.g., a field with goals, and the like. As described above, a map may be displayed having icons indicating that a game is being played at a particular location.

Referring again to FIG. 6, Terry may view a map of scheduled games and their locations from his player profile. Terry may also search for a single game, a recurring game, and/or a tournament in which to play by entering criteria such as the location of the game, the type of game, and other desired search criteria and viewing the map indicating the available games.

The icons may correspond to the type of team sport that is being played at the location, such as a soccer/football or basketball. A player may select an icon that displays another web page having information relating to a game by selecting an icon on the map. A player may create a location and assign an icon to represent the location. The icon may depict an image that is related to the team sport or sports that are played at the location.

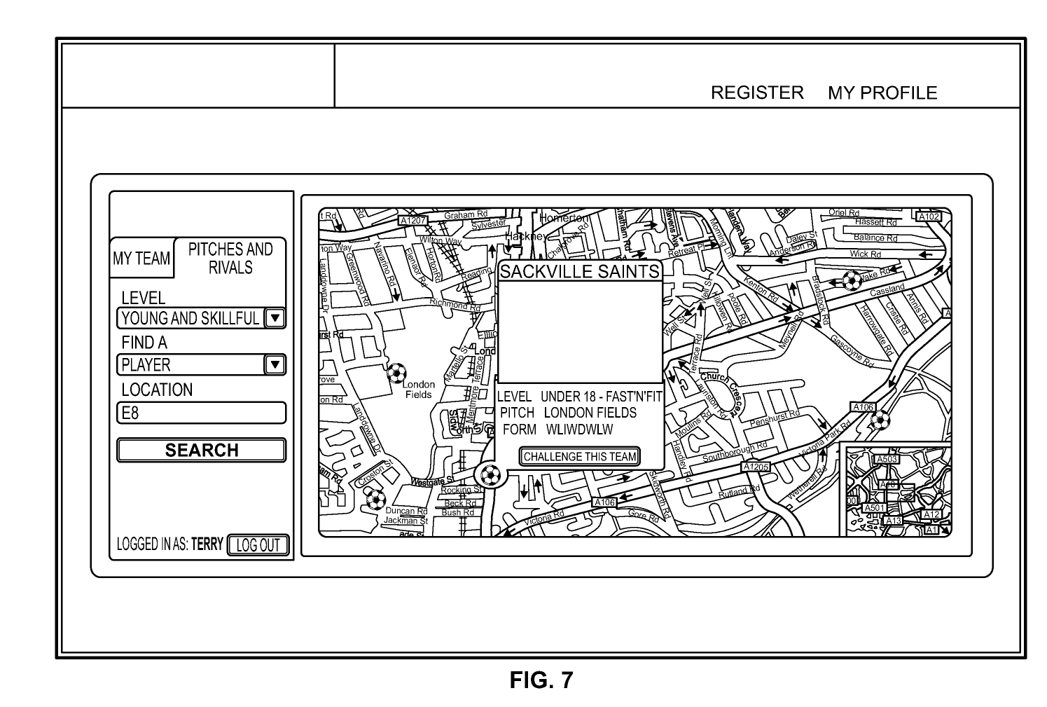

FIG. 7 illustrates a map having a plurality of scheduled games and indicated by an icon depicted as a soccer/football. A team or player may challenge another team that is scheduled to play at a game by selecting an icon at a desired location. For example, FIG. 7 illustrates an icon with a game scheduled for a team called the Sackville Saints. The player profile mentioned in the description of FIG. 6, above, is displayed. Terry has performed a search for games based on a set of criteria including a level, a location, and a player search. Terry chose to search for players at the level of “young and skillful,” which corresponds to the level of skill of the players.

A player, such as Terry, may have an option to search by any skill level, such as beginners, intermediate, and advanced. Players may also have the option of searching for games by age group, gender, and any other desired search criteria. The Sackville Saints may invite another team to join the game or another team may request to join the game by selecting the icon. The Sackville Saints may also invite an opposing team to play in a game by sending an invitation to that team.

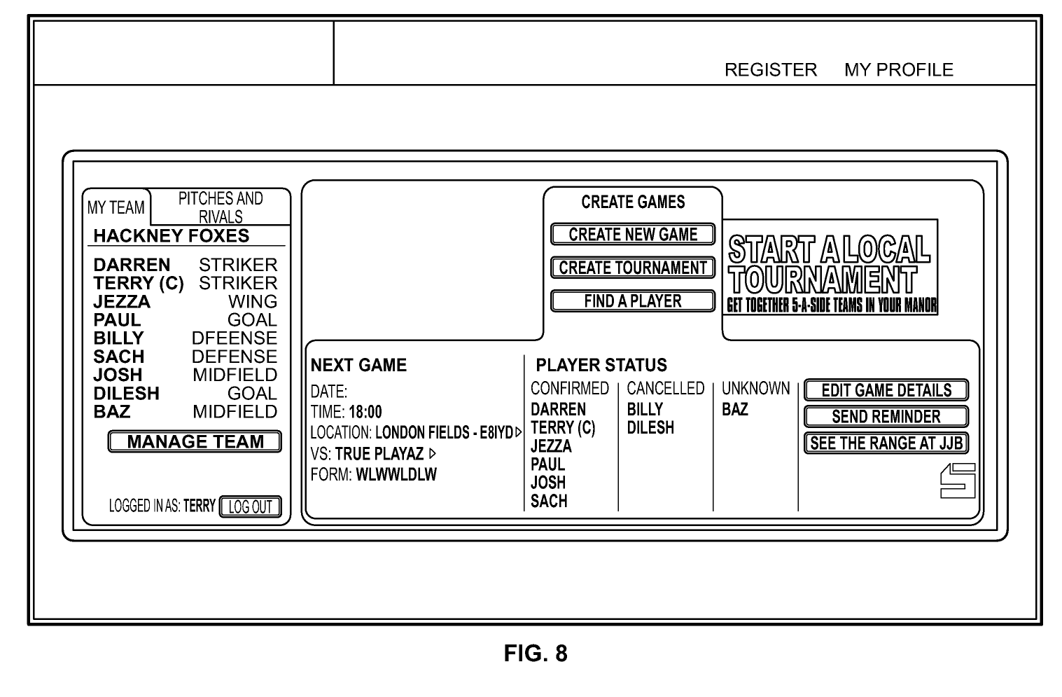

In FIG. 8, the player profile for Terry is illustrated with a web page for creating a game. In this example, Terry's player profile displays the other players on his team called the Hackney Foxes. The other players include Darren, Jezza, Paul, Billy, Sach, Josh, Dilesh, and Baz and their respective positions on the team. A link is provided that permits Terry to manage the team. A manager of a team may have the ability to schedule and create games, training, practice, and the like for the team and invite a player or team to play with or against the team.

The player profile may also illustrate a schedule of the next game that is scheduled for the team on which the player participates. In the example illustrated in FIG. 8, Terry's next game is scheduled for Wednesday, May 25 at 10:00 at London Fields. Terry team, the Hackney Foxes is scheduled to play a soccer/football game against a team named True Playaz.

The player profile web page may also include information about a player's status on whether a player is scheduled to attend the game. For example, in FIG. 8, the Hackney Foxes team comprises players named Darren, Terry, Jezza, Paul, Billy, Sach, Josh, Dilesh, and Baz, as discussed above. Each player may have committed to attend or not attend the game or have been undecided. As illustrated in FIG. 8, Darren, Terry, Jeza, Paul, Josh, and Sach have committed to attend the next game that is scheduled for Wednesday, May 25 at London Fields, while Billy and Dilesh are unable to attend and Baz is undecided.

Players may also have an option to edit games details from a player profile, send a reminder about the game, and view information about the game venue and/or location, as illustrated in FIG. 8. A reminder may be received over any available medium including, but not limited to a telephone, e-mail, text message, and blog.

For example, Terry may decide to change the location of the game from London Fields to Windsor Yard by selecting the link for editing a game from his player profile. Terry may also send a reminder or other message to the team regarding the game. For example, Terry may wish to remind the team of the scheduled game on day in advance. Terry may also wish to remind the team of a scheduled team meeting that will take place before the next scheduled game or a social event that will take place after the next scheduled game.

A player may also create a new game from the player profile web page. In FIG. 8, Terry has the option to create a new game, create a tournament, and search for a player for a game from his player profile by selecting the appropriate link.

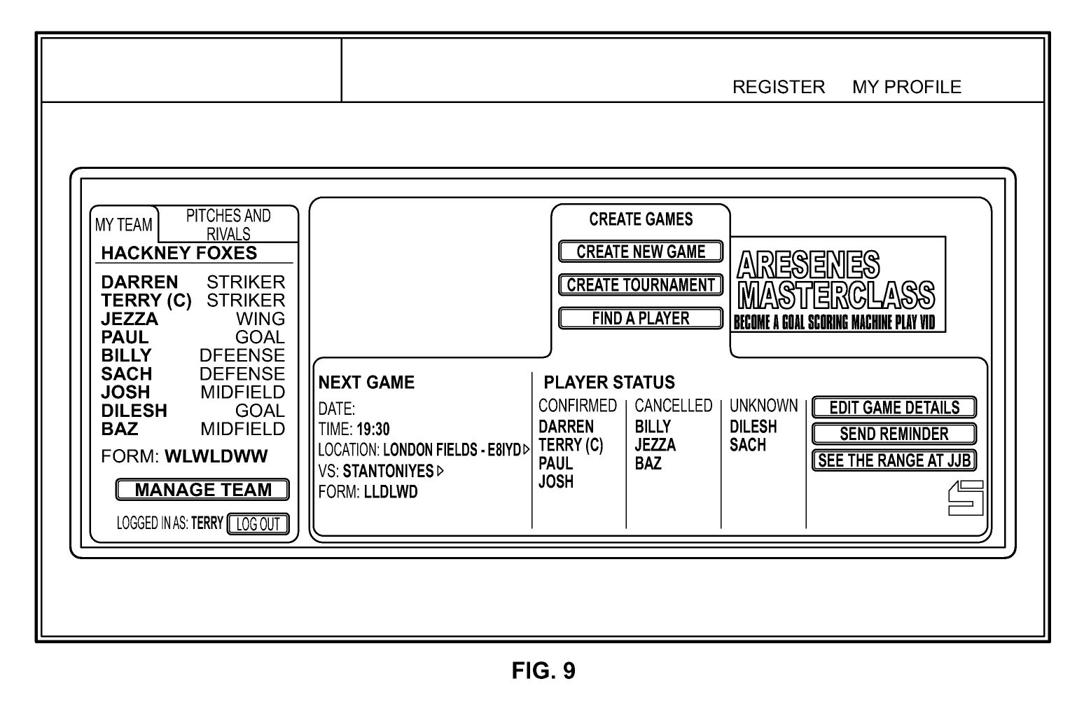

FIG. 9 illustrates another web page from Terry's player profile. In this example, Terry's next game is scheduled for Wednesday, June 11 at 10:30 at London Fields against a team called the Stantonites.

Thus, as discussed, a web page such as shown in FIG. 6 illustrates a location of a team sporting event. A user or player may perform a search from the home page or may input a username and password to access their player profile. The player profile may permit the player to access information about the team sporting events that are already scheduled. Further, the player profile may permit the player to create a new game and post a game for other players to join. In FIG. 6, team called the “Hackney Foxes” will play at a location entitled “London Fields” and may have an icon or other descriptive characteristic associated therewith, including by not limited to text, pictures, figures, scores, and the like, illustrating the type of team sport may be positioned on a map at the location of the team sporting event to indicate the type of team sporting event that is scheduled at that particular location.

The location of the team sporting event may also provide information about the opposing team and may indicate the level, experience, age group, gender, or other demographic of the opposing team. As shown in FIG. 6, a player and/or team may select to challenge another team that is scheduled to play a team sporting event. A first team may challenge a second team by identifying a location, a team, a player, a time, or other characteristic, and posting a challenge on a public or private posting such as a website.

A player or team may create a game or team sporting event as discussed. The player or team may have the choice to include the game in a tournament that includes a plurality of games. The player or team may post the time, the location, the opposing team, and the form or style of the team sporting event, e.g., 3-on-3 basketball team, a 5-A-Side soccer/football game. The player or team may also provide information about the player status for each player that is invited or scheduled to be a position or is invited or requests to fill a position on the team. The player may choose to invite an opposing team and may provide additional information about the types of positions or positions that are needed by the team, the location and time of the team sporting event, and the players that are already positions on the team.

Each player may indicate whether they are confirmed to attend the team sporting event, whether they have canceled their participation in the team sporting event, or whether they are undecided on their participation in the team sporting event. The player or team that created the game may edit the details of the team sporting event, may send a reminder to the players about the team sporting event, and may access information and pictures relating to the weather conditions, the condition of the playing field or arena, the traffic around the location of the team sporting event, etc.

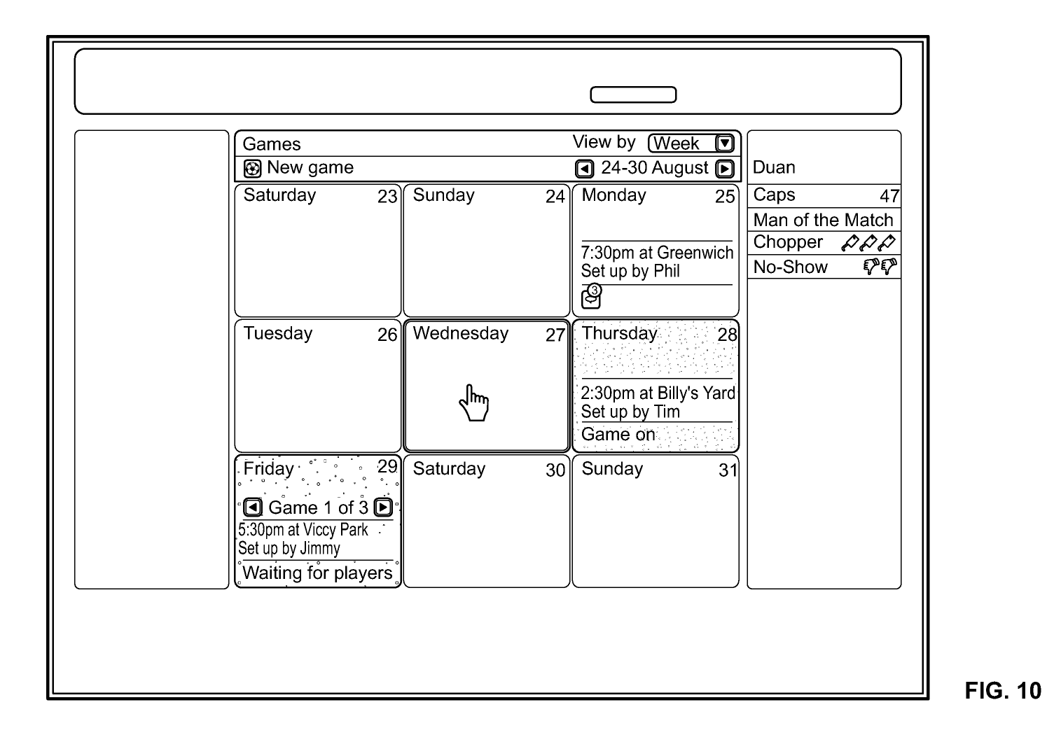

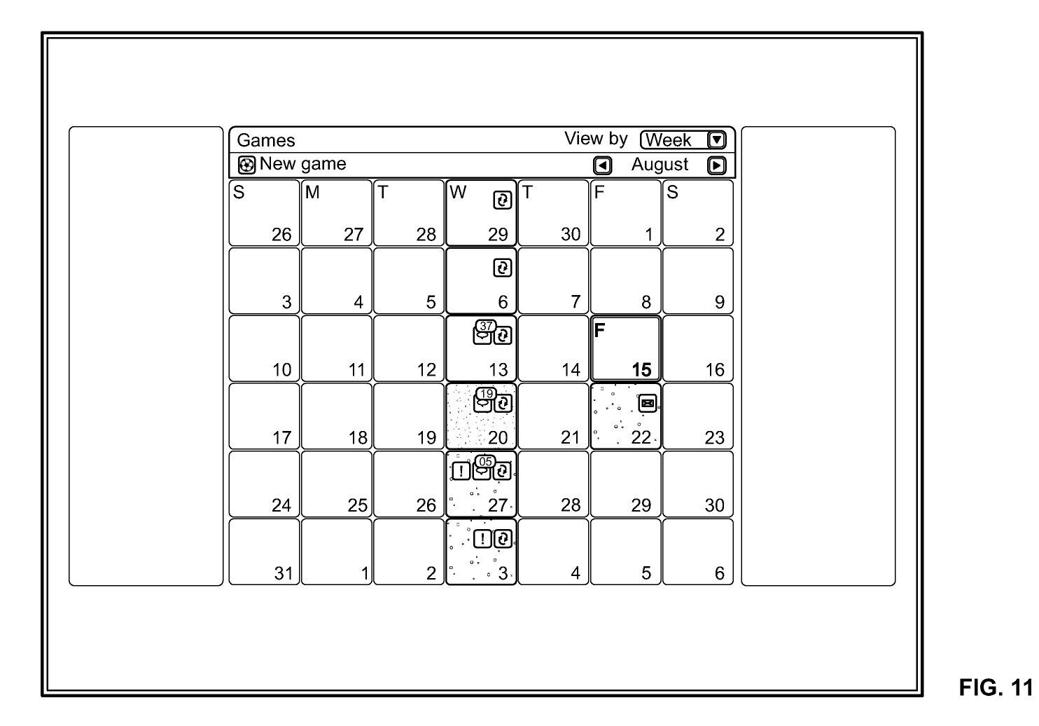

FIG. 10-13 illustrates another example of scheduling a game and creating a game. FIGS. 10 and 11 depict a calendar having several games scheduled. The calendar may be sorted or filtered by the type of game, the players on the team, the team, the date, the month, or any other sorting or filtering criteria. In FIG. 10, a player named Duan Evans has a player profile and a schedule of games. Duan's player profile may be illustrated by displaying his player statistics. Duan's schedule of games includes a game on Thursday, Aug. 28, 2007 at Billy's Yard. Duan may also create a new game by selecting a date, time, and location for a game, such as Wednesday, Aug. 27, 2007 at 7 o'clock in the evening for a new game. Duan may highlight and select the date on the calendar and input the necessary information about the game.

FIG. 11 illustrates another calendar having a schedule of games for a player profile and/or team profile. The calendar illustrates a type of activity depicted by an icon that is scheduled for a particular day. The icon may indicate the type of activity that is scheduled for a particular day such as a game, a practice, a training session, or the like. The calendar may also indicate whether the team has enough players for a game by coloring a date on the calendar with a designated color. For example, if a game has enough players to play each position on the team for a game on Aug. 20, 2007, then the calendar date may be green. If the team does not have enough players to play on a team, such as on Friday, Aug. 22, 2007, the calendar date may be red. Any color may be linked with a particular message.

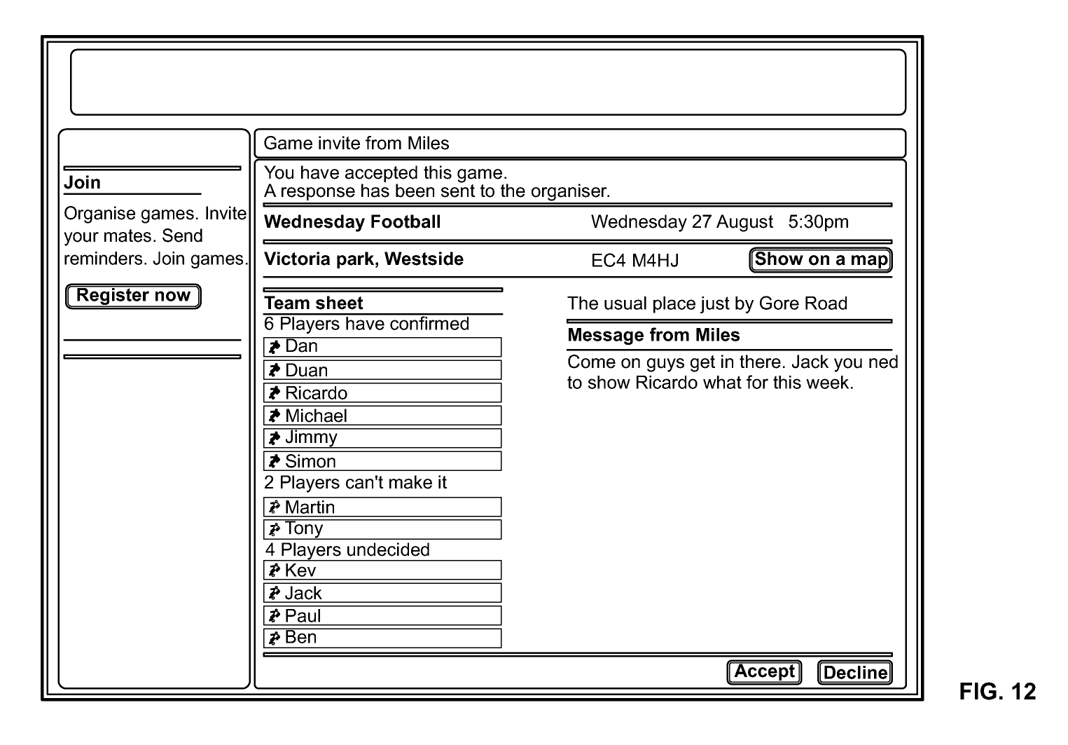

FIG. 12 illustrates an invite for players on a particular team that is scheduled in FIGS. 10 and 11. The invitation may be extended by a player from a player profile or a team from a team profile. The invitation may include information about the game including, but not limited to the time, date, and location of the game. The invitation may also include information about the team and the players that are on the team.

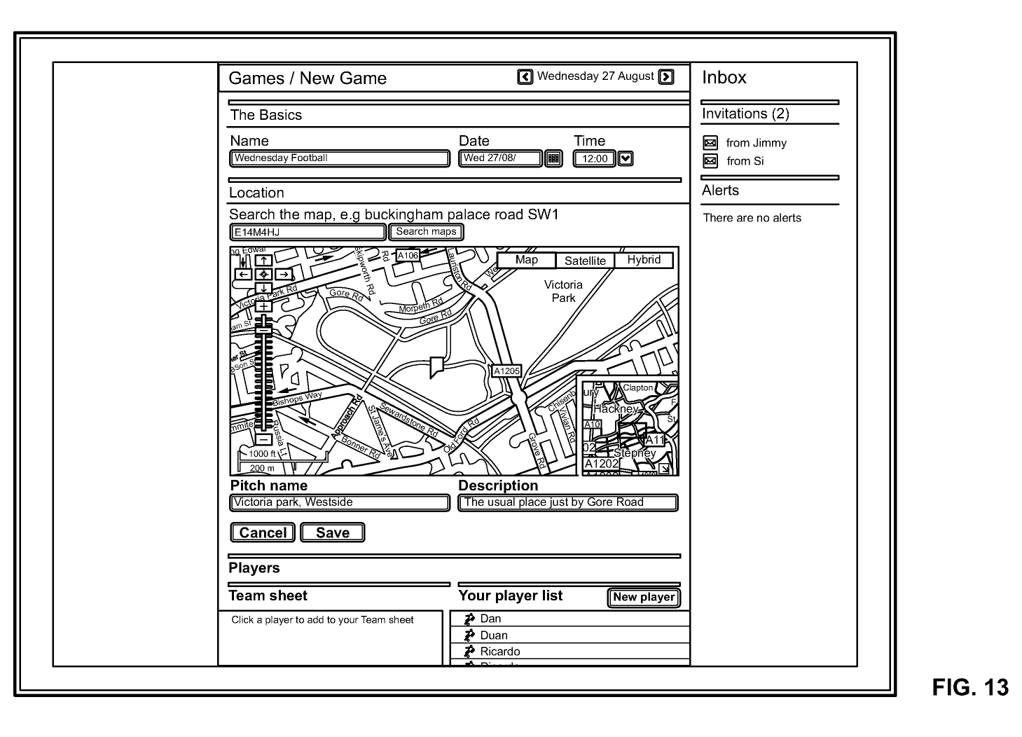

FIG. 13 illustrates a map for an invitation for a game, as described in FIG. 10-12. The map web page may include driving directions with a photo or illustration. In FIG. 13, a search feature is illustrated that provides a player with the ability to search for a location and view a map of the surrounding area near the location. The map web page may also permit a player or team to send an invitation to play at a particular location and to create a game at a location. Accordingly, the system provides an easy method for teams to schedule games with one another. The system further provides additional enhancements such as the mapping features and pitch/field information wherein players can easily find locations of the game. It is understood that messages sent to players from the system regarding games and other team activities may be done via mobile telephones or other wireless devices.

### Team Profile/Player Profile

The system also allows a team to create a team profile and have certain team-related information displayed on a web page such as shown in FIG. 13. The team profile may include information such as the players on the team, the team's statistics, a photograph and/or video of the team, and any other desired information about the team. The team's team profile may function in a similar manner to a player's player profile, as described above.

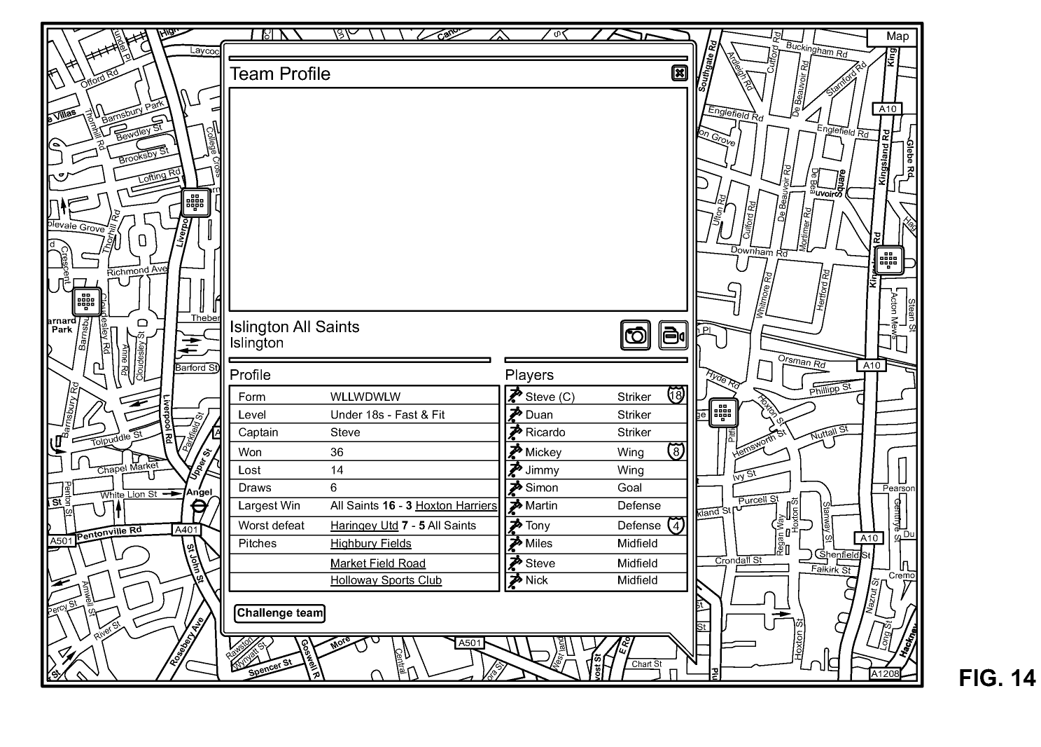

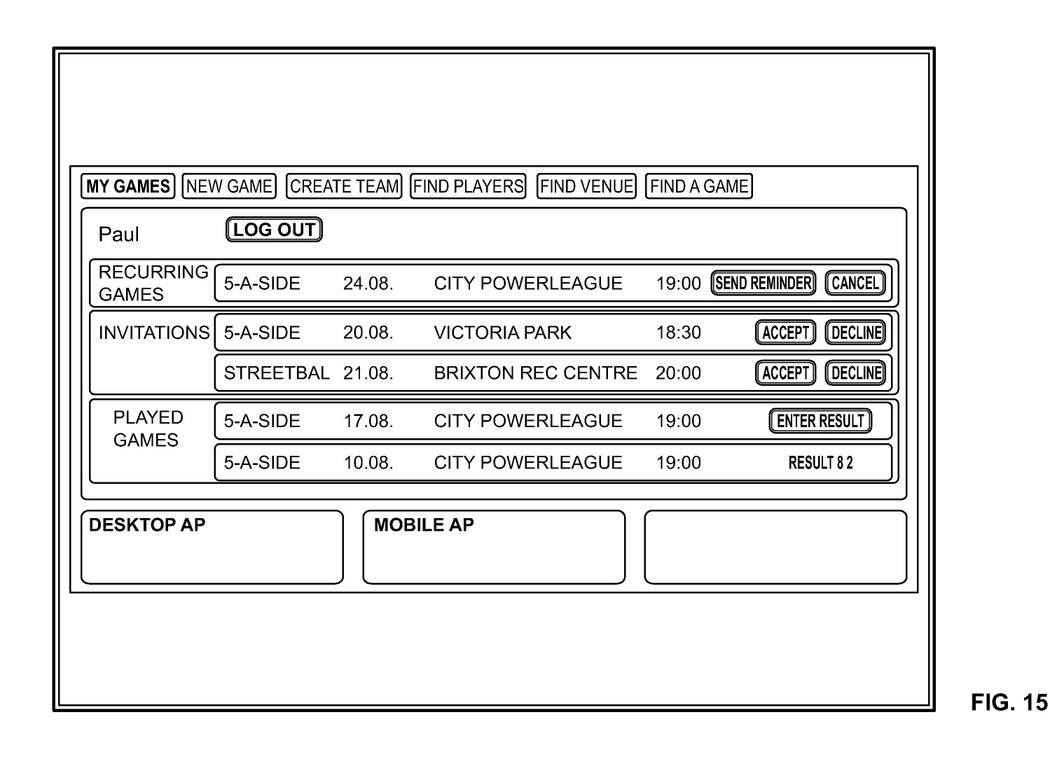

A team profile and/or player profile may permit a player and/or team, respectively, to create a new game, to create new team, to find players for a game and/or a team, to find a venue or location for a game or team, and/or to find a game for a player and/or team, as illustrated in FIG. 14. A player profile is illustrated in FIGS. 15-20. Individual players may opt to create a player profile. The player profile may contain information about a player including, but not limited to, a schedule of the player's games, pending invitations and request for games, recently played games, player statistics, the player's teams, and the like. The player profile page may provide a player with the option of viewing the player's recurring games, upcoming games, games recently gamed, and the like. The player profile may include a link to a variety of features such as a description of the games scheduled for the player, an option to create a new game, to create a team, to find players for a game, to find a venue for a game, and to find a game in which to play.

For example, in FIG. 15, a player named Paul Robins is shown to have a recurring game with the City Power League at 10 p.m. on Fridays. The next game of the recurring series of games is on Friday, Aug. 24, 2007. Paul's team is scheduled to oppose a team named Brixton Bears in their next game.

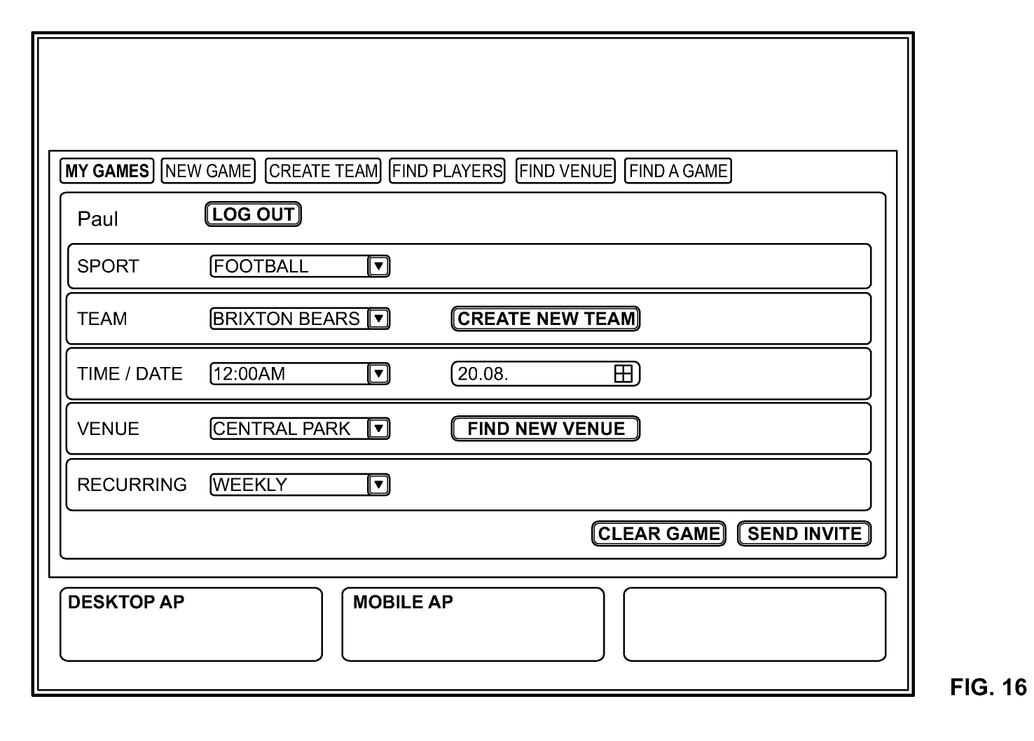

FIG. 16 illustrates a player profile and an option to create a new game. A player may select a team sport, a team, a time and date, a venue, and other game descriptors. The player may also create a new team and may find a venue at which to host the game. For example, Paul Robins may wish to create a new soccer/football game for his team named the Brixton Bears or a new team that he may create. Paul Robins may schedule a new game for 12:00 a.m. on Aug. 26, 2007 at Central Park or any other venue of his choice. Paul Robins may wish to search for venues at which to host the game. Paul Robins may wish to create a recurring game.

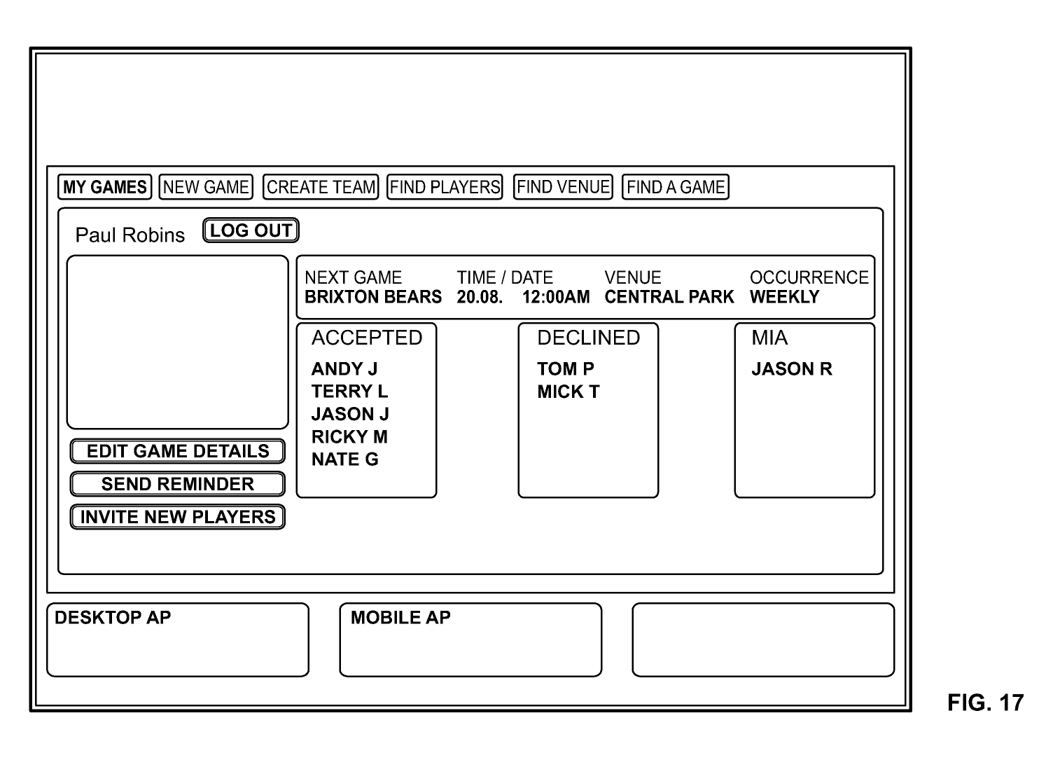

In FIG. 17, a player profile for Paul Robins is illustrated having a view with the games scheduled for Paul Robins. As discussed above, Paul Robins is a player in a soccer/football game that occurs weekly at Central Park. Andy J, Terry L, Jason J, Ricky M, and Nate G have agreed to participate in the next game; Tom P and Mick T have declined to participate in the next game; and Jason R has not responded on whether he will participate in the next game. A player or team may send a reminder and invite new players to participate in the soccer/football game. Further, one or more of the players may be permitted to edit or revise information relating to a game played by the team.

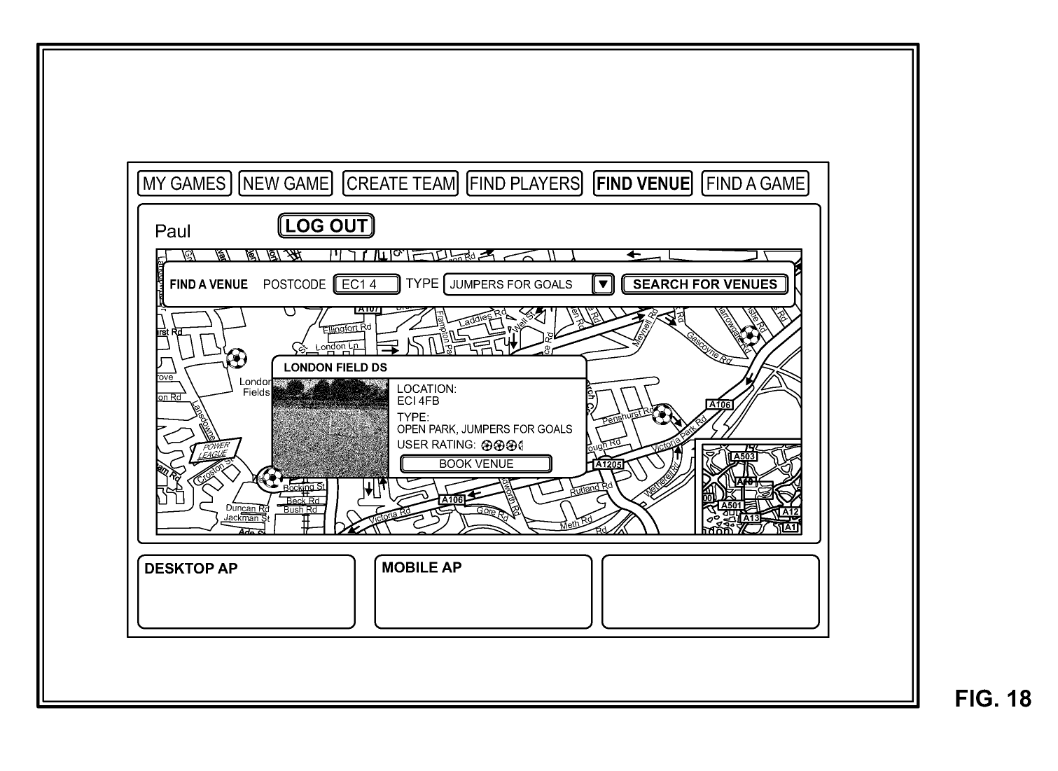

FIG. 18 illustrates a player profile for Paul Robins and a web page for searching for a venue for a game. A player may be permitted to search for a venue by the venue's name, location, type, and other criteria. The player may also be given the option to view a map of the venue and view information about the venue. For example, a map is shown in FIG. 18 in which Paul Robins has performed a search for a venue having certain characteristics including jumpers and goals. A plurality of venues meet the search criteria and may be illustrated on a map, as shown in FIG. 18. For example, Paul Robins performed a search for venues within the postal code of EC14 having jumpers and goals. The search results included fours venues that are each indicated by a soccer ball/football icon. One of the search results location London Fields as having jumpers and goals. Paul Robins selected the link for London Fields and a web page appeared that described the venue. The venue's web page may include a link to book a game at the venue.

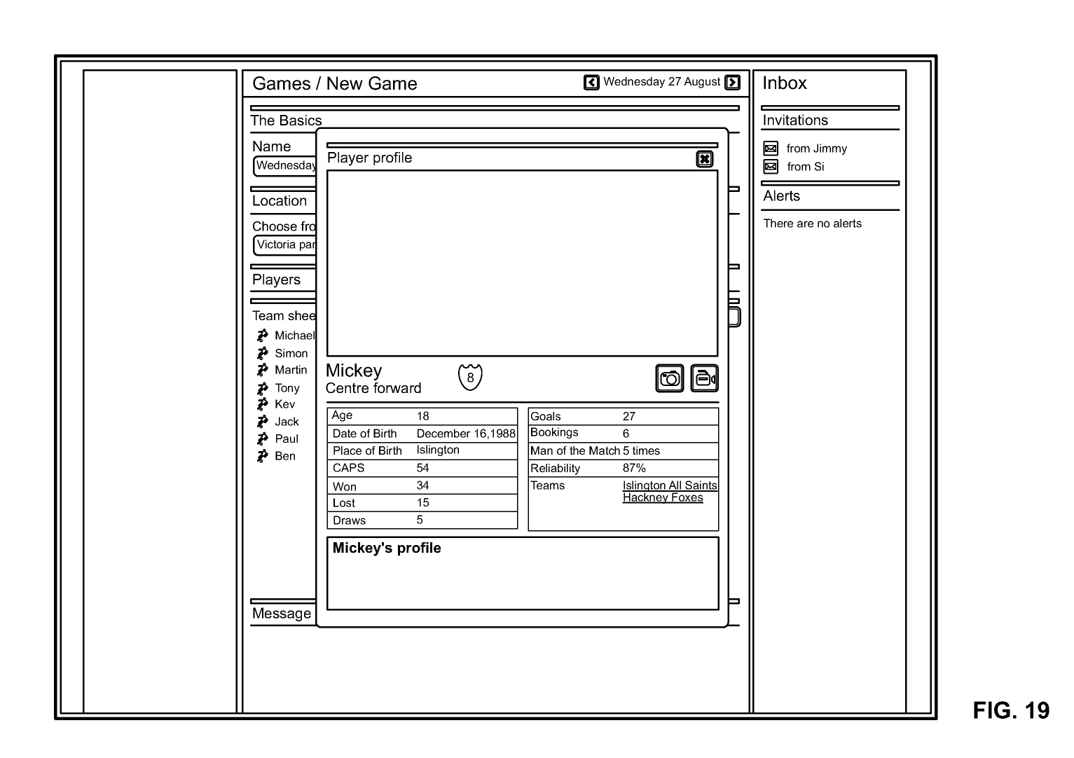

FIG. 19 illustrates another example of a player profile for a player named Mickey Robbins. In this example, the player profile includes information about the player's age, date of birth, place of birth, game statistics, player rankings, awards, teams, and testimonials.

### Searching for Player

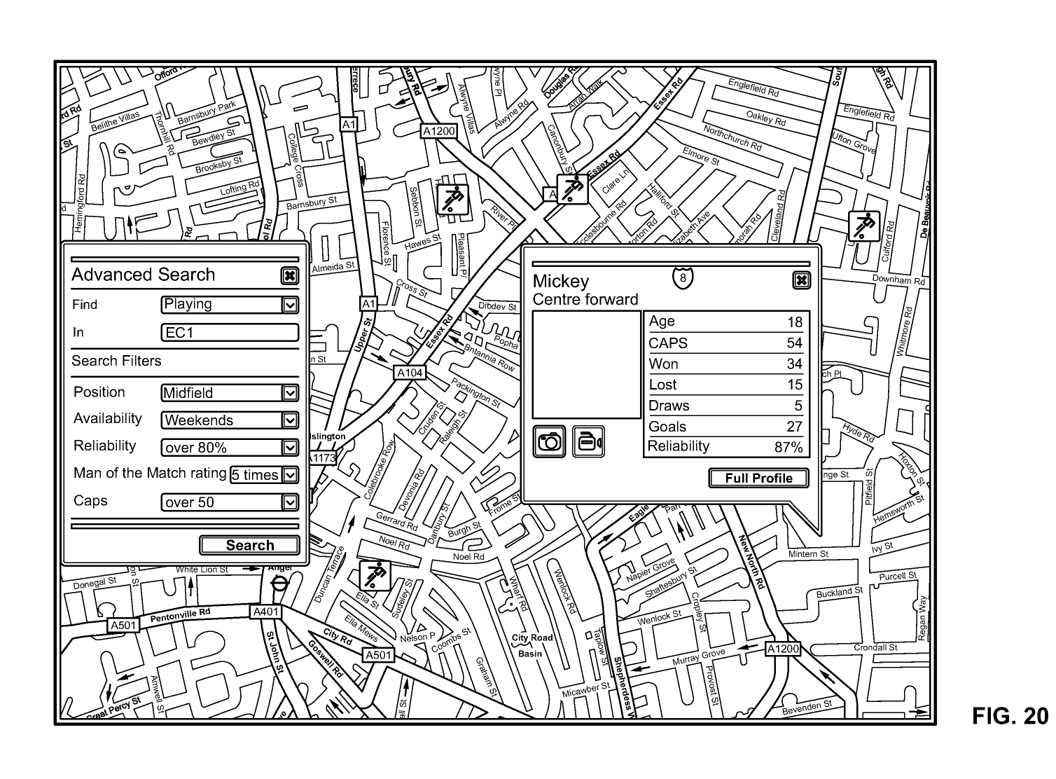

There are times when players on teams are injured, move away from an area where the team is based, or are generally unable to participate in games organized by the team. Thus a team may need to fill a roster spot with an individual player. The system provides a search function to help a team find an individual player. As illustrated in FIG. 20, a team and/or player may perform a search for a player and/or team, respectively.

FIG. 20 illustrates a search page from a player profile web page for Mickey Robbins. The search page may provide a player with the option of searching for players, games, teams, and the like in a particular geographic location or region. The search page may also permit players to search for a game or team that may need a specific player position, availability, reliability, player award rating, and the like. The search page may be used by players from a player profile and teams from a team profile. For example, a player may be unavailable for a game or may quit a team and the team may need to identify a player to fill a specific position. A team may be searching for a player for fill a specific position on the team. The team may perform a search based on the position of the player and may be provided with a list of players that are capable of playing the necessary position.

In addition, there are also situations where individual players are looking for teams to play on, or are searching for individual games in which to participate. The search feature also allows for individual players to post their availability as well as to search for teams having open roster spots. A player may wish to find a team that plays at a particular venue or that plays in a particular league. The player may also search for a team that includes players of similar skill and age.

Once a player is identified in a search, a team or another player may select a link that illustrates another web page including detailed information about the player such as player statistics and contact information. When a team is identified by a player, detailed information about the team may be viewed by the player in a similar manner.

### Personal Social Currency and Rewards

A personal currency or reward system can also be used with the system of the present invention. Players may be awarded currency for good and/or bad actions. A player may perform well in a game and may be awarded a “player of the game” or “man of the match” currency. The player may also be awarded for bad actions such as performing poorly and failing to attend a game. The player may be given a “two left feet” award if the player performs badly in a game or series of games. Attendance awards may be provided to a player for attending a high number of games and for attending games to which the player committed. Other terminology can also be used such as “chopper,” as decided by a system administrator or users of the system.

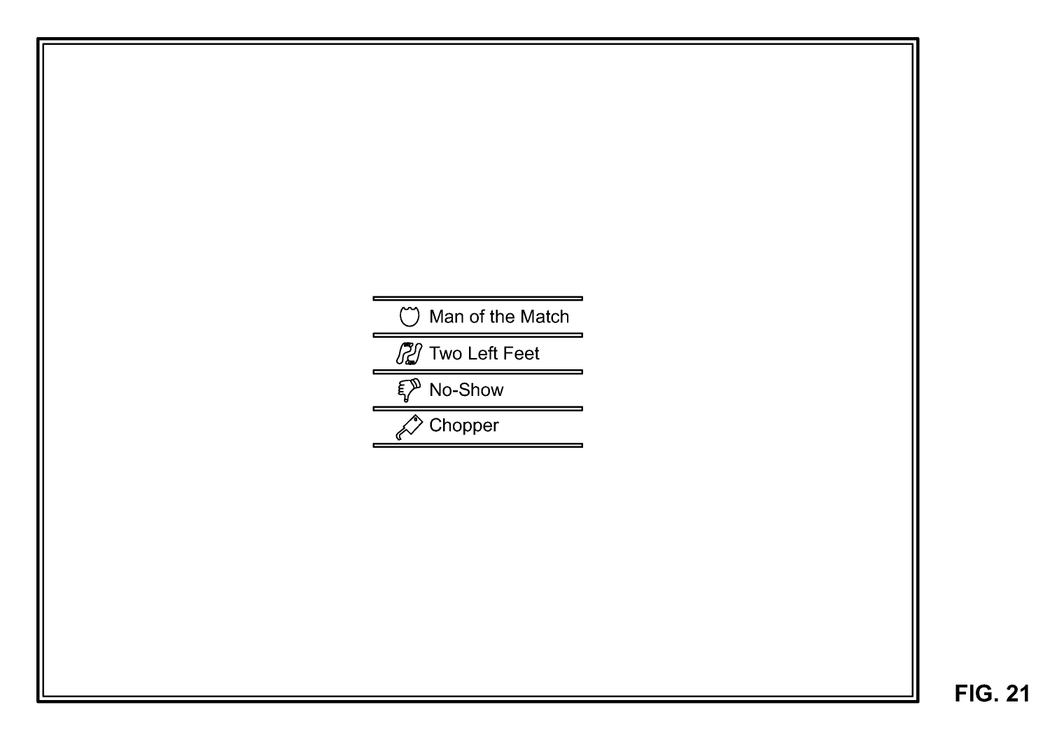

A player may use the currency for increasing his value within the team sport community. The currency value for a player may be displayed on a player profile for the player and may be viewed by other players and by teams. The currency may be used as a testimony to a player's credibility and skill. FIG. 21 illustrates a list of awards that may be offered to a player including “man of the match,” “two left feet,” “no-show,” and “chopper.”

The currency may also be used for awarding prizes such as merchandise, admission to a private training session, and the like. In another example, a tournament winner can be provided with additional product, promotions, or web content associated with their team. Focused professional athletic training can also be included in the rewards system. The reward system can have different tiers based on number of wins or other playing data.

Connecting with Social Platforms

The system also provides for the ability for teams and players to further connect with external social networking organizations. For example, links can be provided to a social network that may incorporate the information from a player profile and/or team profile into the social network. For example, a player may have an profile on a social network and may use the social network for communicating with other people, listening to music, viewing videos, and the like. The player's profile from the team sport community may be integrated with the social network in a seamless fashion. The social network may import all of the information for a player and player profile into the social network.

### Player Forum

Additionally, the system may include a message system. The message system may be a running posting of messages, such as a web log or “blog,” and may also be a messaging system that sends an email, text message or other short message to a selected group of recipients. The message system may be viewed publicly or privately and may be accessed for viewing by all or a portion of a group of players or teams. The message system may include any desired method of sending and posting messages. The message system may be a separate component of the system or may be incorporated into other system components such as the team profile pages or the player profile pages.

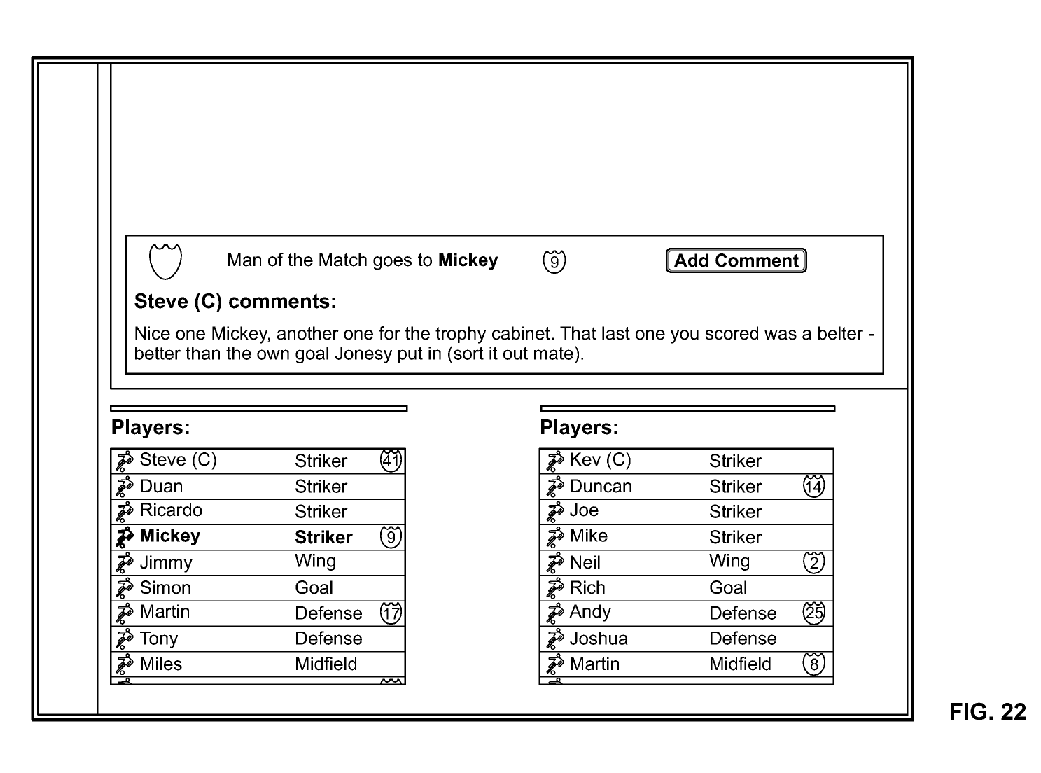

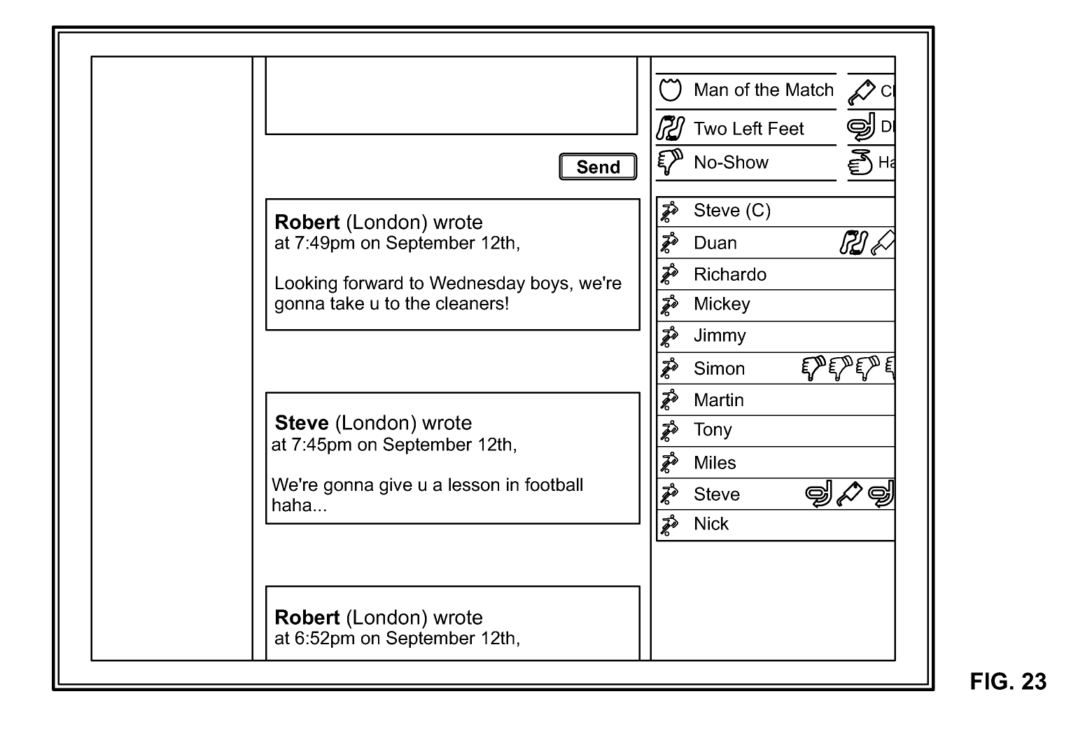

FIGS. 22 and 23 illustrates a blog or communication forum for communication between players. Players may wish to communicate with one another before or after a game and may wish to post messages regarding a game. The communication forum may also be used to post information about a player's and team's performance during a game and may be used to award a player with a currency. For example, in FIG. 22, Mickey Robbins is awarded a “man of the match” award or currency for a recent game. In the same example, Steve Kemp, posted a message to express support and congratulations to Mickey Robbins for a good performance during the game. FIG. 23 illustrates an example of a web log that includes messages from Robert Walsh and Steve Smith before a game.

### Field Database

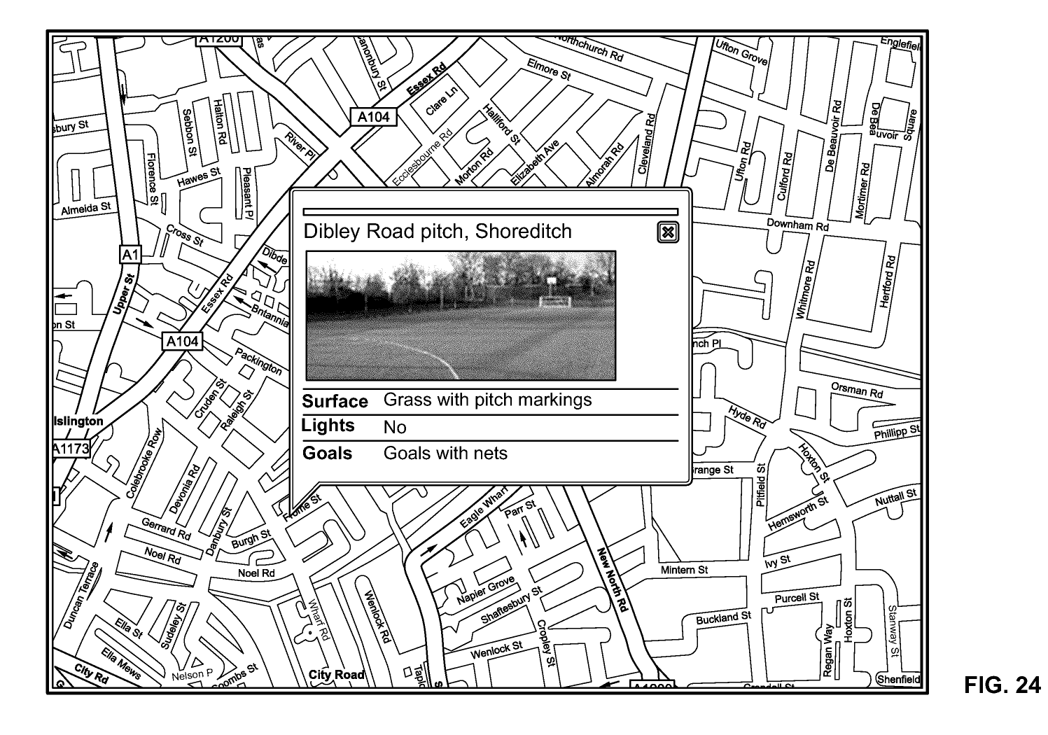

The team sport community may include information about a venue and the facilities at a venue at which a team and players play, practice, and train. For example, FIG. 24 illustrates a map indicating the geographic location of a venue called Dibley Road pitch, Shoreditch. A photograph of the venue is provided and information about the type of surface of the fields at the venue. Information about whether the venue provides lights for a night game is also included, as well as information about whether the venue has goals and what type of goals they have. Any desired information about the venue may be included and displayed. The database can be referenced by teams and players in deciding where to schedule games. A comments section could also be incorporated into the database for players to rate the field.

### Player Challenges/Tournaments

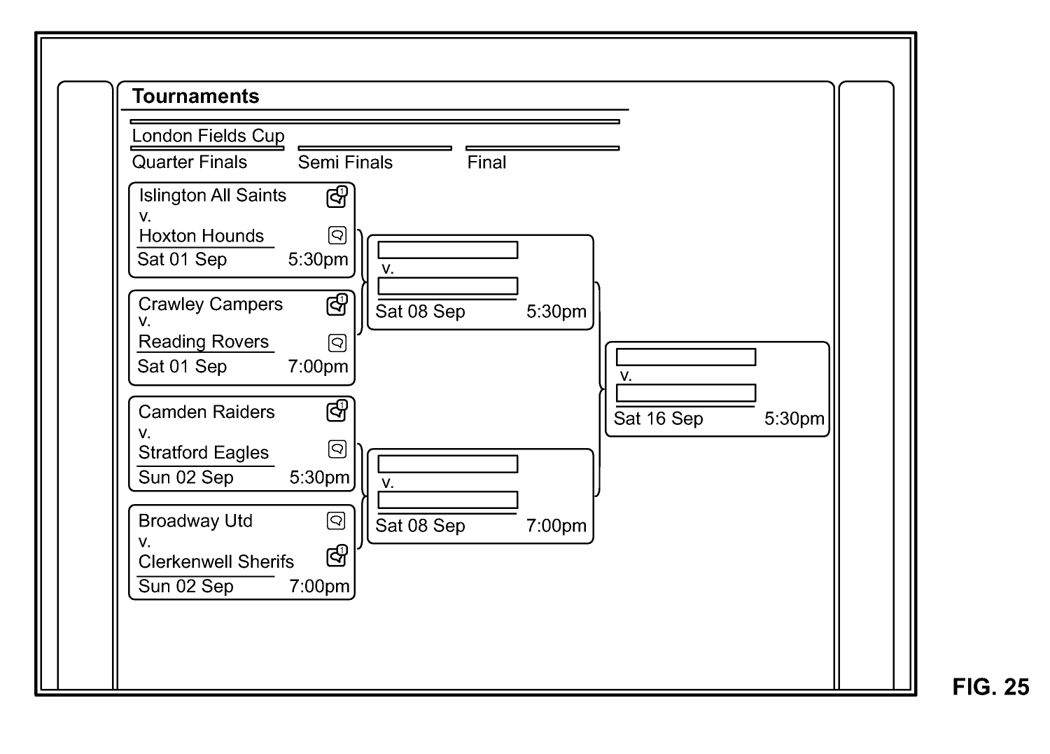

With the present system, players can also issue challenges to other players. For example, one player can challenge another player or group of players to a game or training goal. The player or team may also challenge another player or team to a tournament, as described below. The challenges may be used to improve a team's or player's skills and reach milestones of achievement. As illustrated in FIG. 25, players and teams may organize a tournament in which a plurality of teams participates. Typically, a tournament comprises several teams that play several games against one another. Winning teams often advance to another game to play the winner of a different game. FIG. 25 depicts the quarter finals, semi-finals, and finals of a tournament named the London Fields Cup 2007.

### Training Opportunities

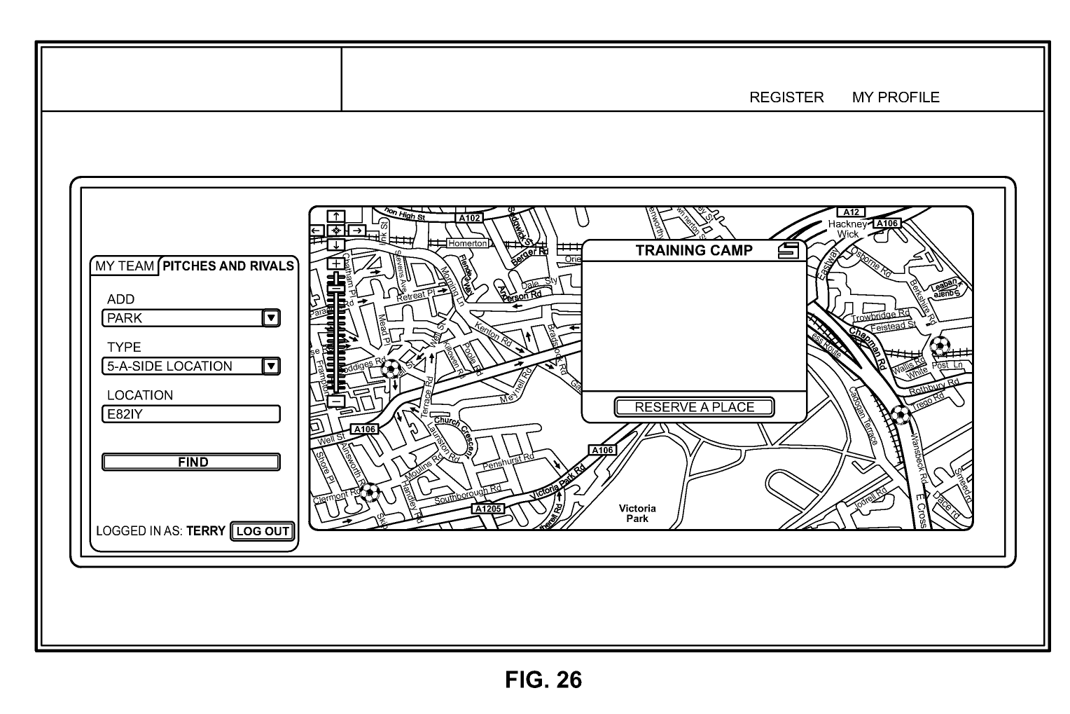

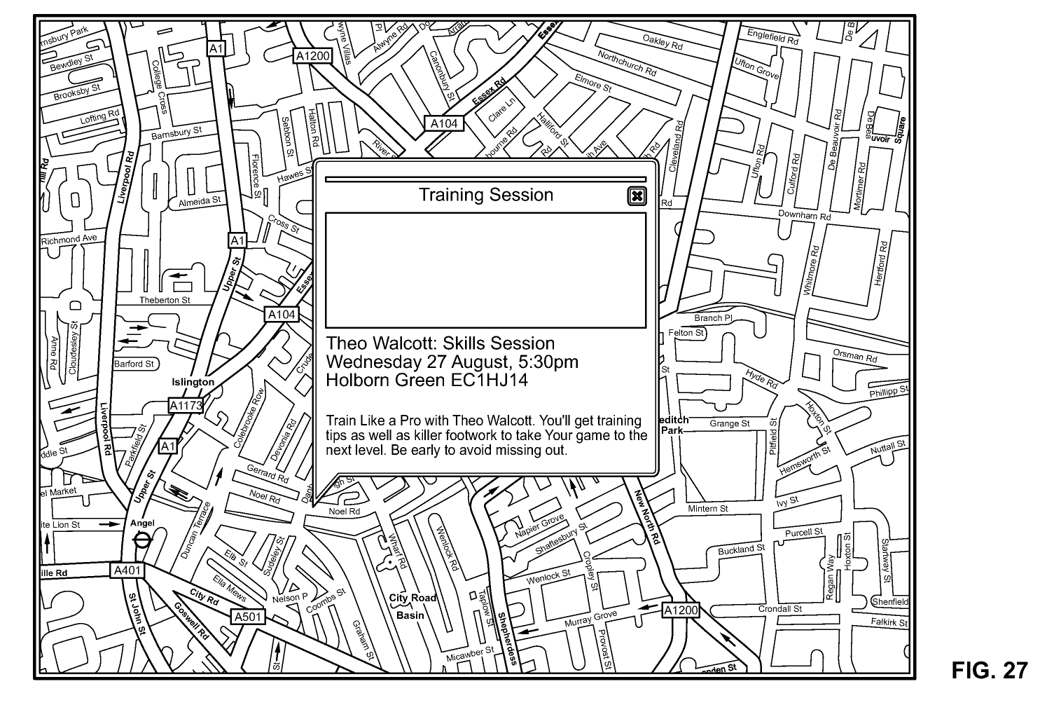

The system can also provide for training opportunities such as by highly-skilled or professional athletes, as illustrated in FIGS. 26 and 27. For example, a training camp may be organized for a location and/or by a team or player. The training camp may provide a player or team with the ability to practice fundamental and advanced skills, attend training sessions by other athletes, coaches, and trained professionals, and the like. The training camp may be hosted by a player, a team, a location, an organization, such as a manufacturer of sporting equipment that may be used during the team sport, and the like.

FIG. 26 illustrates a map showing the location of a training camp. A player or team may be permitted to reserve a location or venue for a training camp and may be able to create a training camp for other players and teams to attend. FIG. 27 illustrates a location on a map for a training session. In this example, a training session has been scheduled by a professional athlete on Wednesday, August 27 at 5:30 p.m. at Holborn Green. A brief description of the training session may be included, as shown in FIG. 27 as well.

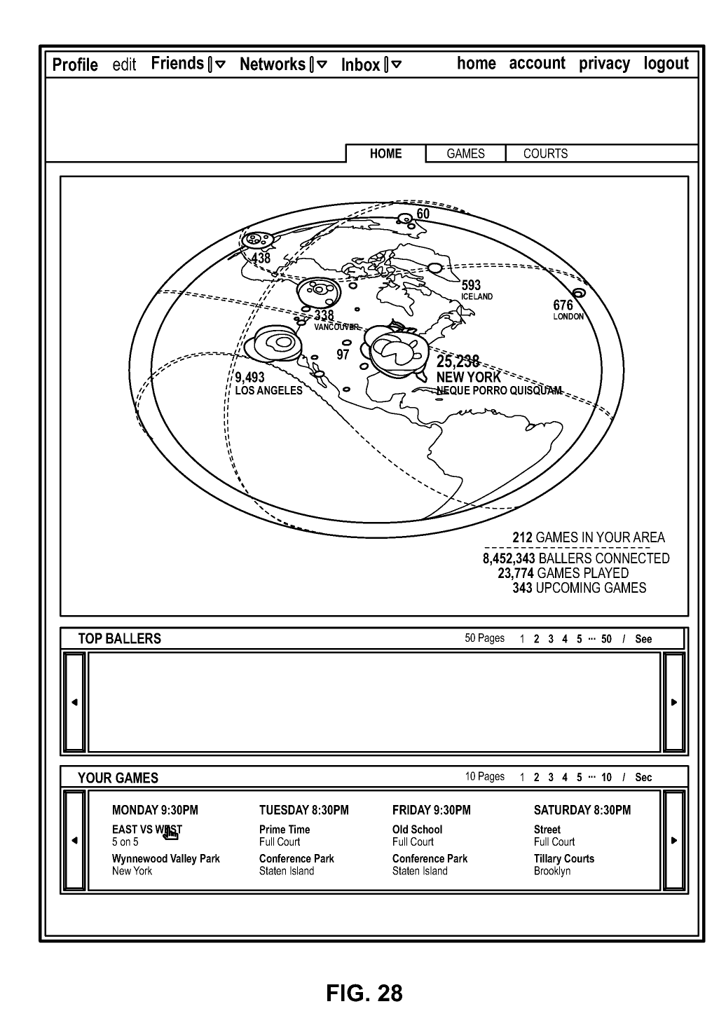

FIGS. 28-36 disclose another embodiment of the system and method of the present invention relating to a team sport focused on basketball. It is understood the features described above apply equally to the embodiment of FIGS. 28-33. A basketball game may embody many forms including, but not limited to, two teams that each include a five positions, three positions, or a single position, e.g., “one-on-one.” Any feature described in either the football example described above and/or the basketball example described below may be implemented in any sports' team sport community. Additional features that are unique to a particular sport may also be implemented in the team sport community, such as how a team is selected, particular sport rules, and the like.

FIG. 28 illustrates a home page for a basketball community. The home page includes information about the games that are currently being played, registration of a player and/or team, the statistics about a player and/or team, and the like. As discussed in the embodiment above, a player may create a player profile. In this example, the player profile may include information about the player's upcoming basketball games and the teams on which the player participates. The home page may also present one or more games that are occurring or scheduled for play within a time period (such as a day, a week, a month, or the like) of the date and time of the player access of the player profile.

For example, FIG. 28 illustrates a globe with a plurality of locations that may include Long Beach. Long Beach may have one or more basketball games that may be scheduled for current or future play. The home page may indicate that a game is being played at Long Beach by a red dot or light or any other indicator (e.g., an icon, an image, an alphanumeric text, or the like).

In some examples, a concentration of games and/or locations may be available or may be searching for a player, players, or an opposing team. At the Long Beach location illustrated in FIG. 28, a plurality of courts may be made available to players. The locations may each be identified on a map or other locating device and may be indicated by a dot, icon, image, color, or other indicating feature.

The home page may also include information relating to the number of games that are being played, the upcoming games, and the players that may be currently connected to the team sport community.

The home page may provide links to additional web pages that may be accessible to a user having a player profile. The additional web pages may include, but are not limited to a games web page for creating a game, searching for a game, providing feedback about a game, or the like. The additional web pages may also include a players web page for searching for a player, posting available player opportunities, providing feedback and/or assigning a rating to a player or a group of players, and the like. The home page may additionally include a link to a web page at which a player and/or team may invite another player and/or team to join a game, a tournament, a warm-up, a practice, a fundraiser, a competition, or any other basketball event or activity.

The home page may include information relating to a player or a group of players. For example, in FIG. 28, a group of players designated “Top Ballers” may be identified on the home page. The Top Ballers may be players that have earned a high rating or score for their play and/or their sportsmanship. The Top Ballers may include an image that represents an individual player or a team. A group of teams receiving a high rating or score may also be displayed or presented on the home page in the same or a similar fashion as the Top Ballers.

The home page may also include a link to another web page having upcoming events. The upcoming events web page may include information on basketball events, games, practices, competitions, warm-ups, professional games, tryouts, etc. and the location at which the event may be hosted.

A player or group of players may invite another player to join a team, a game, or create a new game from the home page or a link presented on the home page. An invitation may be sent directly from the home page (i.e., an invitation appears directly from the home page after selecting the invitation option) or may be sent from a separate web page that may be accessible from the home page.

A player may have a player profile that describes the player's experience, ratings, scores, records, rankings, or any other identifying information relating to the player. When a player may be needed to join a game, a user (player, team, coach, etc.) may search for a player and may retrieve several player profiles. The user may compare the features and/or qualities of two or more players by comparing the information included in each player profile.

A player and/or a team may have a ratings system that assigns a score or rating to each player and may assign a score or rating to a group of qualities or characteristics of a player or team. The players and teams may be rated by themselves and may be rated by other players and/or teams. The ratings characteristics may include a win/loss record, game statistics, sportsmanship, experience, and the like.

A player or team that receives a rating or score in one or more categories may use the rating or score as social currency. Social currency may be used to earn or to purchase items or privileges such as tickets to events, entrance to a training camp, an opportunity to meet or play basketball with a professional athlete, an invitation to attend a private event, merchandise or equipment, or the like. The social currency may also include privileges such as being selected to test a new product or the ability to purchase products on a discounted basis or at a restricted time (such as before the product is released to the public).

A leader board may be generated or created that may reflect information about the players and/or the teams that have high ratings or scores. The leader board may include information relating to the individual player's quality of play, comments from teammates or opponents, endorsements, recommendations, or the like. A search for players or teams may include criteria for those players or team that may be included on the leader board.

The leader board may celebrate the achievements of players or teams in the team sport community. For example, if a player is selected for a scholarship or a professional position, the player may be honored on the leader board. In another example, a team who recently won a tournament may be honored on the leader board as well. The leader board may be configured to showcase the activities occurring within the team sport community and may be continuously updated with information from games in any location and across the world.

The self-generated information from a player or team may be integrated with a social network. The information may be linked together to provide current information for a user, player, team, or other entity visiting the team sport community web page and the team or player's web page in the social network. The social network web pages may be individually operated by a player or team and may contain personal, team, or professional information that may not be included on the web page for the team sport community. Additionally, a message may be sent to the player or team through the team sport community web page to the individual or team's web page in the social network. Conversely, a message may be sent from the individual or team's web page in the social network to the team sport community web page. In essence, the two networks may be integrated and linked to reflect portions of similar or related information relating to an individual, a team, or any other information. The information contained in the team social network may be synced with the information contained in the team sport community. Such information may be automatically synced when it is changed or revised. It also may be automatically synced periodically (such as once per day or hour). Such integration between the social network and the team sport community may provide seamless communication between all networks that a player joins.

The home page may have links to web pages for sponsors of basketball events or manufacturers or sellers of basketball products. The home page may also have links to web pages that may be maintained by a professional team, a news or broadcast television or radio station, a personal or team web page, or any other web page.

### Create a Game

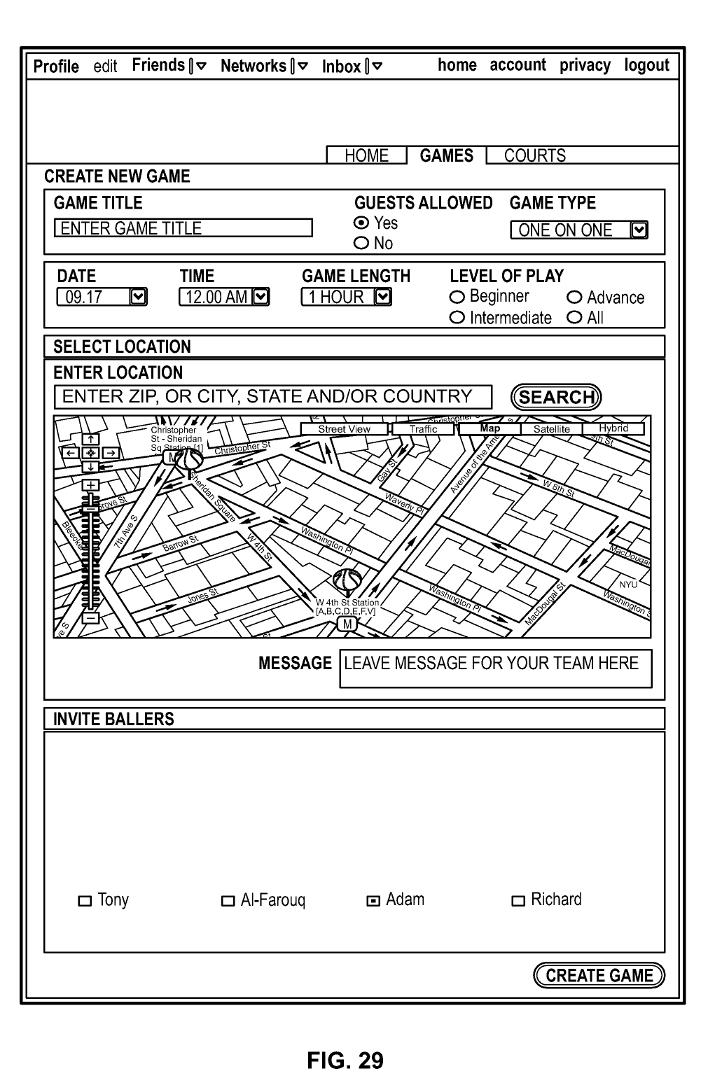

FIG. 29 illustrates an option to create a new game. The option to create a game may be accessible from a create game link presented to a user on the home page or may be directly accessible via a uniform resource locator (URL) entered by the user. The option to create a new game may include selecting a venue on a map, inputting the proposed time, date, length of game, and location, and searching for players for a game. For example, FIG. 29 illustrates a web page for creating a new game in which a player may select two venues, a first and a second venue. The venue may be illustrated with an icon, an image, or another indicator, such as a basketball as illustrated in FIG. 29.

Each venue may be selected by a user or player and may provide the user or player with information about the game, the venue, the players, the teams, the location, transportation or directions to the venue, and the like. The venue may also indicate when a game is restricted by a feature, such as skill level, gender, age, or the like. For example, a game that may be scheduled for play at the first venue and may be restricted to males, between ages 14-17 years having an advanced skill level. Any restrictions or no restrictions may be assigned to a game, a player, a venue, a location, or any other feature of the team sport community.

The map illustrated in FIG. 29 may indicate transportation suggestions for the first venue and the second venue. For example, the first venue may be located near a subway or metro station named Christopher St.-Sheridan Sq. Station [1] and a second venue may be located near a subway or metro station named W 4^{th} St. Station [A, B, C, D, E, F, V]. The venue and the metro station may be indicated on map, as illustrated in FIG. 29. The first venue and the second venue may be illustrated by a basketball and the metro station may be indicated by a subway or metro logo, such as a large “M.”

A mapping or direction feature may provide the player a map of the streets and/or areas surrounding the venue and/or with directions from a location to the venue at which the game may be played. The direction maps be drafted in text, may provide related information (such as distance between the starting point and the venue) and may also provide map indicating the recommended route between the starting point and the venue.

The web page for creating a game may include designating whether guests are allowed and whether the game may be a private or public event. The type of game may also be indicated, such as a one-on-one, three-on-three, practice, shoot around, or other type of game, competition, practice, or event.

The create a game web page may include a feature for a player or a team to leave another player or team a message. The message may include information about the game, the venue, the players, the team, upcoming events, cancellations, or the like. The message may include any suitable information.

### Upcoming Games/Events

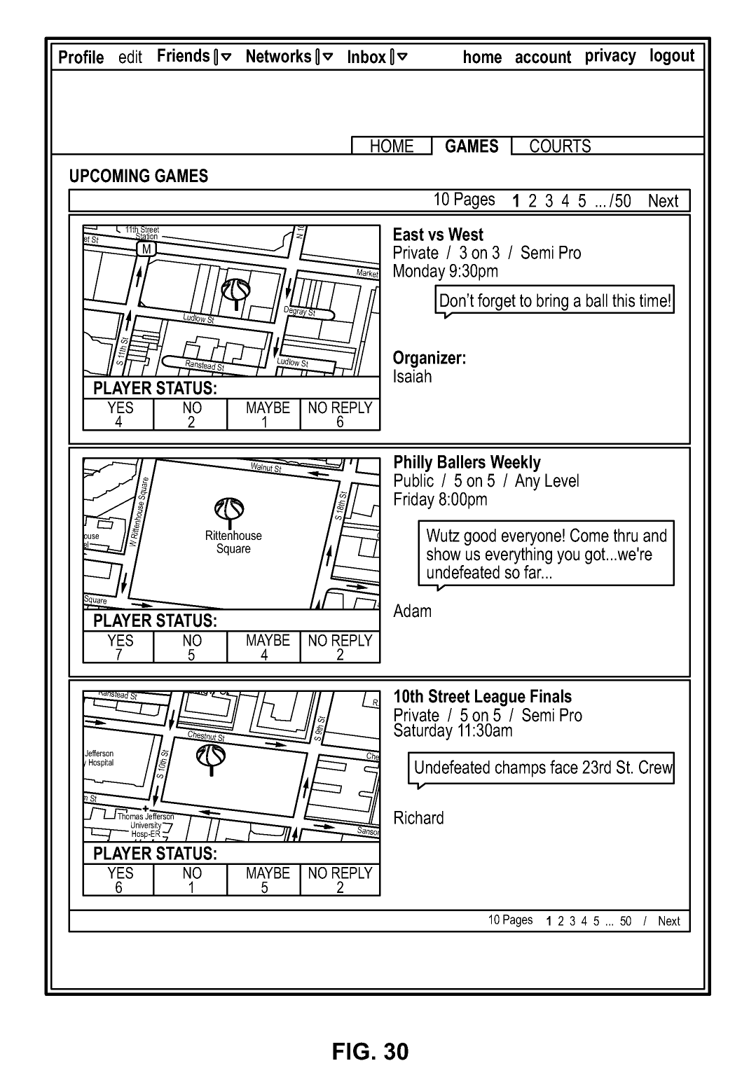

FIG. 30 illustrates a web page that lists the upcoming events for a basketball community. The upcoming events may include games, training sessions, practices, meetings, social events, and the like. In FIG. 30, a game between the East and the West is going to be played on Monday at 9:30 p.m. The game may include three players on each team and players skilled as a “semi” professional. The players may post messages to one another and may be permitted to view whether the other players have committed to attending the game. The message may be any messaging form, including but not limited to, short message service (SMS), electronic mail (e-mail), instant message, telephone call or voicemail message, or any other electronic, written, or otherwise communicated message.

Each game, such as the East vs West game, may include a map that indicates the location of the venue for the game, the time, date, and location of the game, the organizer of the game (with a corresponding image, photograph, icon, or the like), and any other information relating to the game. The game or a sporting event may be recurring. For example, a game may be recurring one time per week on Wednesday evenings at 8 p.m.

In another example, a game may occur weekly, such as the Philly Ballers Weekly game illustrated in FIG. 30. As described above, the game may have features or restrictions on the players, the skill level, the age, whether it is private or public, the time, date, location and venue, the organizer, or any other suitable feature or restriction. For the Philly Ballers Weekly, the game occurs each Friday evening on 8:00 p.m. and is a public, 5-on-5 game (five players are recommended or required for each team). All skill levels are permitted to play in the Philly Ballers Weekly and the game is played at Rittenhouse Square, as illustrated by the map positioned adjacent to the game information on the upcoming games web page.

### Find a Game

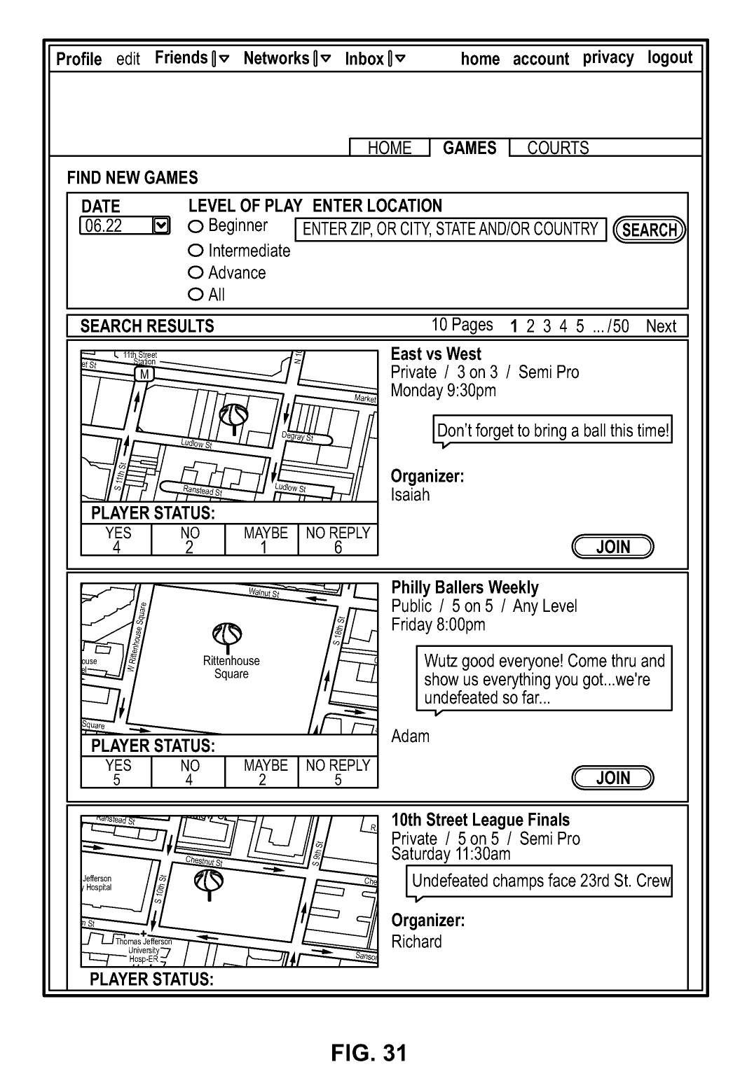

FIG. 31 illustrates a web page that provides a player or team an option to search for new games. The player or team may search by a particular set of criteria. For example, in FIG. 31, a player may search for games by date, level of play, and the location. The level of play may include a plurality of levels or all levels and may correspond to a corresponding skill set defined by subjective and/or objective criteria. For example, players may be designated as a beginner, an intermediate, or advanced. Each skill level may correspond with a defined set of skills (i.e., field goal %, free throw %, blocked shots, steals, fouls, experience) and/or subjective criteria, such as a player rating that may be assigned by another player, teammate, spectator, fan, team, coach, or the like. The new games web page may also include a feature that may permit a player and/or team to search for a game by the location by name, address, venue features, or other identifying information.

As described above in reference to FIG. 30, a game between the East and the West is going to be played on Monday at 9:30 p.m. The game may include three players on each team and players skilled as a “semi” professional. The players may post messages to one another and may be permitted to view whether the other players have committed to attending the game. The message may be any messaging form, including but not limited to, short message service (SMS), electronic mail (e-mail), instant message, telephone call or voicemail message, or any other electronic, written, or otherwise communicated message. In the East vs West game, a player and the organizer named Isaiah Armwood posted a message to the web page stating, “Don't forget to bring a ball this time!” The messages may be any suitable message, although they may be screened for appropriate content before they may be posted to the web page.

As mentioned above, each game, such as the East vs West game, may include a map that indicates the location of the venue for the game, the time, date, and location of the game, the organizer of the game (with a corresponding image, photograph, icon, or the like), and any other information relating to the game. The player may have the option to obtain directions from a starting point to the game/venue. The directions may be in text form and/or may be an illustration in a map form of the surrounding geographic area and/or the recommended route.

In another example, a game may occur weekly, such as the Philly Ballers Weekly game illustrated in FIG. 31. As described above for FIG. 30, the game may have features or restrictions on the players, the skill level, the age, whether it is private or public, the time, date, location and venue, the organizer, or any other suitable feature or restriction. For the Philly Ballers Weekly, the game occurs each Friday evening on 8:00 p.m. and is a public, 5-on-5 game (five players are recommended or required for each team). All skill levels are permitted to play in the Philly Ballers Weekly and the game is played at Rittenhouse Square, as illustrated by the map positioned adjacent to the game information on the upcoming games web page.

Players, teams, organizers, coaches, sponsors, or the like may wish to organize a league or a tournament. Typically, an administrator may organize a league and may be permitted to contact players and/or teams regarding league play. The administrator may be permitted to communicate with venues or locations within an area at which games may be played. The administrator may establish league play, select teams that will compete against one another, and organize officiating for the games. The administrator may also receive payment for league play or may assign players to a team.

Players, teams, coaches, sponsors, retailer, equipment manufacturers, and the like may organize a tournament. A tournament may be a set of one or more games that may be used to define an ultimate winner. For example, 8 teams may participate in a tournament. During a first round of the tournament, four games are played resulting in four first round winning teams and four first round losing teams. The four winning teams advance to a second round of the tournament and the four losing teams are eliminated from the tournament.

The second round of the tournament may include two games, each having two first round winning teams compete against one another. The two games of the second round of the tournament result in two second round winning teams that advance to the final round of the tournament and two second round losing teams that are eliminated from the tournament. The final round includes one game in which the two second round winning teams compete against one another and the final round winning time is determined. The final round winning team may represent the winner of the tournament. A tournament bracket may be generated that reflects the progression of each winning and losing team. The tournament may include any type of tournament. For example, the tournament may be a single elimination tournament, a double elimination, a round robin, a “losers' bracket” style, and the like.

### Courts Database

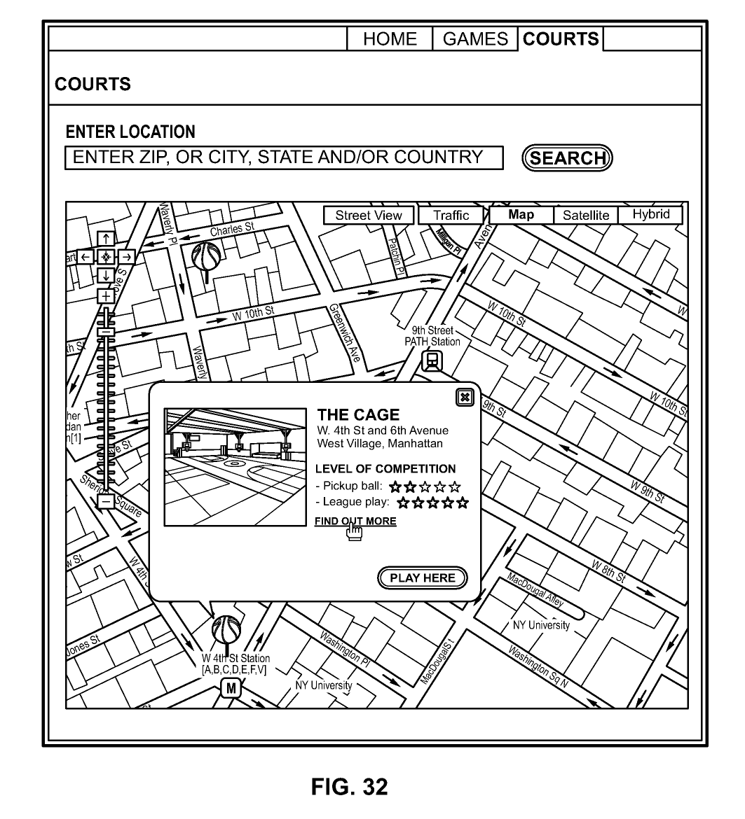

FIGS. 32-34 illustrate a web page for finding a court or venue on which to play basketball game. The court may be outdoor or indoor and may be public or private. A public court may permit any player to join the game and may permit spectators or fans to watch the game. A private court may indicate that a game is scheduled for play at a private residence or property. The organizer of a private game may restrict access to the web page for a private game or the detailed information regarding the private game, such as location, date, time, players, etc. The organizer may allow guests to join the private or a public game and may permit a guest to post a public message to the web page for the game or send a private message to a player or team. A player performing a search for a game may not view the private games or the information relating to the private games.

FIG. 32 illustrates a courts web page for searching for a court or venue. A court database or data store may store information relating to one or more of the courts at which a basketball game may be played. For example, FIG. 32 illustrates that a search for a court may be performed by the location features or details. The location features may include a zip code, a city, a state, and/or a country. The location details may also include an address, a name of a venue or location, the name of a team or player that may frequent a location, or any other search criteria relating to a court or venue.

A map may illustrate the results of a search for courts and may indicate the specific location (or address) of a venue at which a basketball game may be played. The venue may be indicated by an icon, image, photograph, or other indicia, such as a basketball. Each venue may have a venue profile. The venue profile may include identifying information for the venue such as street address, metro stations within a close proximity, photographs of the court, type of games, players, teams, etc. associated with or permitted to play at the court. The venue may be illustrated as positioned on a map indicating the street address and/or driving or walking directions to arrive at the venue's location. The map may include a street view, a traffic report or live feed view, a map, a satellite view, or a hybrid view of more than one aforementioned feature.

Any number of courts may be included in the group of courts that may be available to a player and/or team. For example, a group of 1000 courts may be included in the court database, in which 100 of the courts are marked as a private court. A player conducting a search for a public game in which to participate would be able to view results including 900 of the public courts and zero private courts.

Each court may be rated or scored on one or more features, including but not limited to the quality of the facility, the level of player skill, the officiating of the games (and whether officiating is available), and any other feature of the court. A player or team may rate the court on one or more feature or any combination of features. A fan, spectator, coach, or any other entity or individual may also rate or score the court.

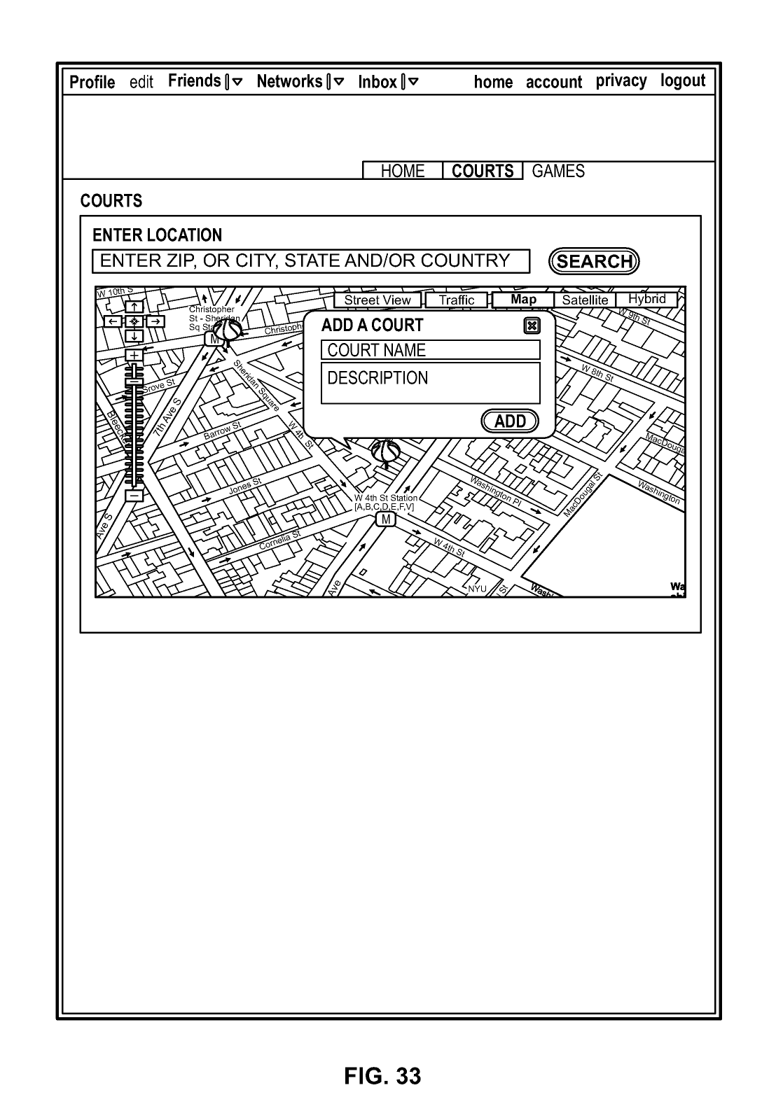

As illustrated in FIG. 33, a court may be added to the court database by a player, a team, a coach, a spectator, a fan, or any other entity including other sports related organizations such as a sports magazine publisher. The entity adding the new court to the court database may be asked to include the court name or may be requested to assign a court name to the location. The entity may also be asked to add a description of the court and its features, level of player skill, types of competition or games played at the court, etc. The court database may be updated to include the new court once it is added. The court database may be updated on a regular basis or may be updated, as a court is added.

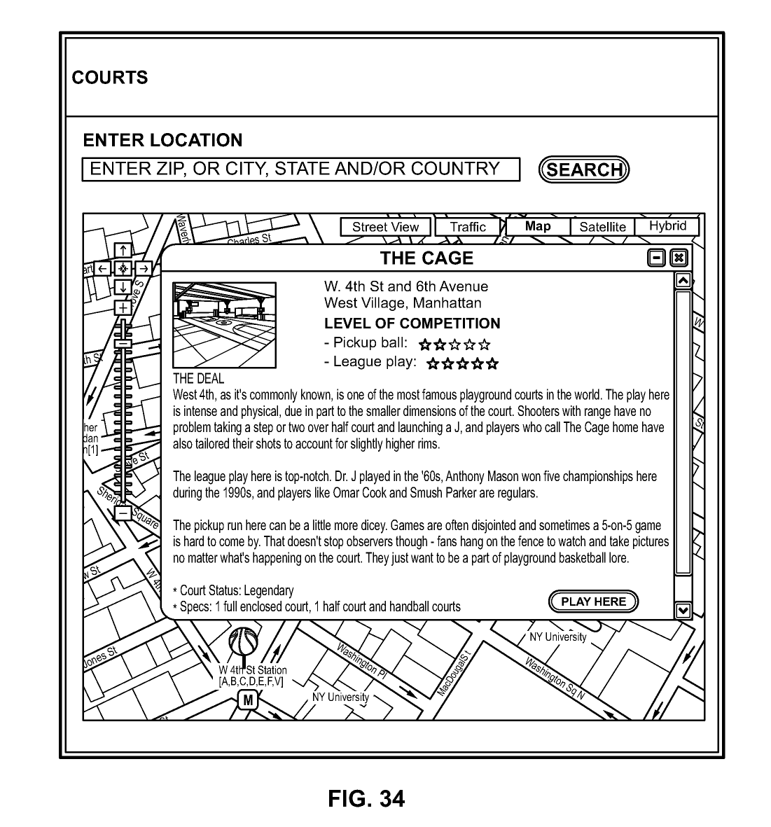

FIG. 34 illustrates an example of a court and identifying information for the court. The name of the court is “The Cage” and it is located at W. 4^{th} St and 6^{th} Avenue in the West Village of Manhatten. Players are permitted to play a pick-up basketball game there and may organize basketball leagues to play at The Cage. The court, the type of basketball, the skill level of the players, and feedback of players experiencing games at The Cage may be included in the detailed information or feedback section of the court profile.

The court may be assigned a status, such as new, street, competitive, professional, half court, legendary, or the like. The specifications of the court may also be included in the description such as the number of courts and the type of courts available. The specifications may also include whether a court or field for another sport may be available to players and other amenities situated at the venue.

Each of the courts in the court database may permit a player to join the game or play in the game. For example, a player may perform a search for available games and may view results that include The Cage, as illustrated in FIG. 34. The player may join the game or request to join the game by selecting the “play here” link.

### Results Information

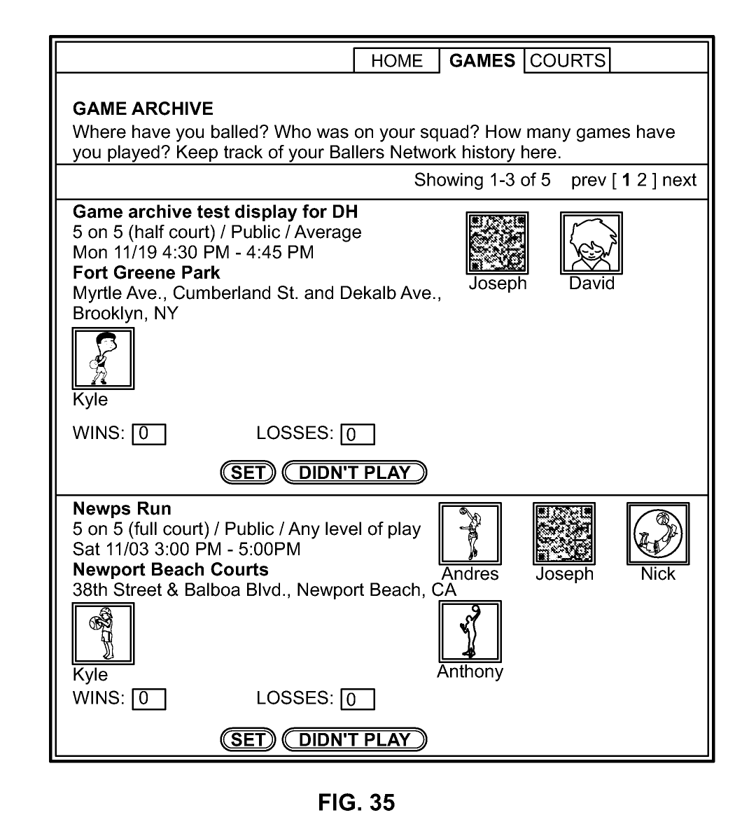

FIG. 35 illustrates a web page associated with results of games and archives of game results. The game results may include information relating to the individual players' performances during a game and the teams' overall performance during a game. The game archive web page may include information relating to the venues at which a player or team has played a basketball game, the teammates that played on a team, the experience of the players and the teams, the win/loss record of a player or team, or the like. The game results information may be recorded by the player or team themselves or may be entered by another player, team, coach, organizer, or other entity.

A game archive may be created or generated from game results and/or player information that has occurred (games that have concluded). A continuous history of current player and team statistics may be compiled to indicate wins and losses and ratings associated with players and/or teams. These ratings may be included in the overall scores and ratings of a player or team. The game archives may include a search function for a player or team to search for archived games and statistics or other details associated with the archived games.

### Player Ratings

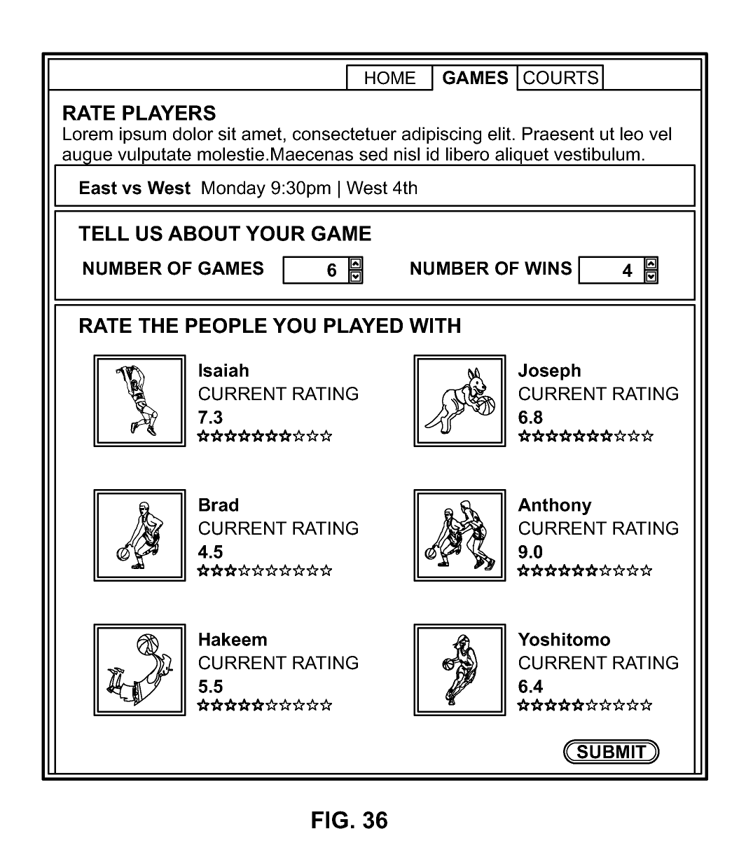

FIG. 36 illustrates a web page for rating players and may include a plurality of links to a player profile. Each player profile that has been rated may be displayed on the rating players web page. Each player may be rated or scored on a plurality of criteria and may be assigned an overall rating or score. As illustrated in FIG. 36, a player named Isaiah may be assigned a player rating of 7.3. The rating may reflect the level of skill and professionalism assigned to him by himself and/or other players.

The rating may evolve over time, as more information is compiled relating to the player or the team being rated or scored. The ratings and scores may be continuously updated and may reflect the most recent or current statistics for a player or a team.

The present invention provides several benefits. Team organizers can more easily schedule games with various other teams. Individual players searching for a new team, an additional team, or just looking to play in an individual game can more easily find teams and games with the system of the present invention. The system reduces the amount of time typically required in organizing games, leagues or tournaments. This allows teams and players to play games more often thus increasing fitness and skill levels and overall enjoyment of their respective sports.

Additionally, players may showcase themselves for recruiters or sponsorship. The recruiters may offer players scholarships to play as a member of a college team, compensation for a professional team, or an offer to play with elite athletes in highly skilled competitions such as the Olympics or other basketball championships. Recruiters may utilize the team sport community to identify high quality players and coaches.

Manufacturers and retailers may capitalize on the team sport community to market their products to players, fans, and the like. The manufacturers and retailers may offer sponsorship to a player or team in exchange for advertisement during a sporting event attended by the player or team. For example, a player may be paid a sum of money if the player is willing to wear a jersey that includes a manufacturer's logo or slogan.

### Merchandise

Merchandise may be available for sale on the sporting community. The merchandise may be sporting goods, articles of clothing and footwear, tickets to sporting events, and the like. Merchandise may be purchased for money or social currency that is described above. Merchandise may be customized for a particular team or player. The customization may be based on the information collected about a player or team over a period of time.

### Bulletins

Users may post bulletins relating to the sporting events, teams, players, or any other information. Bulletins may be a weblog or “blog” messages or information exchanged between one or more players or teams. The bulletins may provide information regarding an item for sale, advertising a competition, recruiting players or teams for a sporting event, or the like.

### Advertising

One or more entities may advertise on the sporting community system. The advertising may be targeted to a particular user or team. The entities may track information about a team or player and may customize the advertising based at least in part on historical data, statistics, player preferences, or the like.

### News

Articles or other news may available for viewing on the sporting community. The articles may include information about the sporting events, teams, players, or the like. The articles may provide sporting event results, statistics, ratings, rankings, and sport related information.

### Current Status

The sporting community may track the current status of information relating to sporting information. The current status may reflect the most recent information about the number of players searching for games, the number of teams looking for players, the number of games that are scheduled or being played, and the like. The current status may be continuously updated when new information is available.

Aspects of the invention have been described in terms of illustrative embodiments thereof. Numerous other embodiments, modifications, and variations are within the scope and spirit of the appended claims. For example, the steps illustrated in the figures may be performed in other than the recited order, and that one or more steps illustrated may be optional in accordance with aspects of the disclosure. Of course, the methods and systems of the above-referenced embodiments may also include other additional elements, steps, computer-executable instructions, or computer-readable data structures. In this regard, other embodiments are disclosed herein that can be partially or wholly implemented on a computer-readable medium, for example, by storing computer-executable instructions or modules, or by utilizing computer-readable data structures.

We claim:

1. A social network for sporting activities, comprising:
a memory having a plurality of modules, including:
a user profile module for storing user profile information including at least a first user profile and a second user profile;
a sporting activities module for storing information relating to at least one sporting activity;
a messaging module storing information relating to messages from the first user profile and/or the second user profile;
a computer interface for receiving a first input relating to a first sporting activity; and
a processor for configured to evaluate the first input based at least in part on the information stored in at least one of the user profile module, the sporting activities module, and/or the messaging module.

2. The social network recited in claim 1, wherein the computer interface is a computing device that is configured to communicate over a mobile network.

3. The social network recited in claim 1, wherein the computer interface is a computing device that is configured to communicate over a mobile network and a computer network.

4. The social network recited in claim 1, wherein the computer interface and the output device are contained in a mobile computing device.

5. The social network recited in claim 1, wherein the input is a message from the first user profile to the second user profile.

6. The social network recited in claim 1, wherein the sporting activities module contains information relating to scheduling a sporting activity.

7. The social network recited in claim 1, wherein the first user profile includes a team.

8. The social network recited in claim 1, wherein the first user profile includes a player.

9. The social network recited in claim 1, wherein the input is a request to create a new game.

10. The social network recited in claim 1, wherein the input is feedback about a player.

11. The social network recited in claim 1, wherein the input is feedback about a team.

12. The social network recited in claim 1, wherein the input is feedback about a venue at which the sporting activity occurs.

13. The social network recited in claim 1, wherein the input is a bulletin message.

14. The social network recited in claim 1, wherein the input is a request to schedule a recurring game.

15. The social network recited in claim 1, wherein the first profile includes a skill level of the first player.

16. The social network recited in claim 1, wherein the input is a challenge from a first player to compete against a second player.

17. The social network recited in claim 16, wherein the first player is associated with the first user profile and the second player is associated with the second user profile.

18. The social network recited in claim 1, wherein the sporting activity is a training opportunity.

19. The social network recited in claim 1, wherein the output device further includes a display for displaying information relating to the sporting activity.

20. The social network recited in claim 22, wherein the information displayed by the display includes the user profile information, the sporting activities information, and/or the messaging information, wherein each of the user profile information, the sporting activities information, and/or the messaging information is continuously updated.

21. The social network recited in claim 1, wherein the first input includes a video and/or image relating to the sporting activity.

22. The social network recited in claim 1, wherein the first input includes a video and/or image relating to a player.

23. The social network recited in claim 1, wherein the first input includes a video and/or image relating to a team.

24. The social network recited in claim 1, wherein the first input includes a video and/or image relating to a venue.

25. The social network recited in claim 1, wherein the information relating to the first user profile is private.

26. The social network recited in claim 1, wherein the information relating to at least one of the messages is private.

27. The social network recited in claim 1, wherein the first user profile has a first quantity of social currency.

28. The social network recited in claim 27, wherein the social currency is earned by a player for good actions.

29. The social network recited in claim 27, wherein the social currency is exchanged for merchandise.

30. The social network recited in claim 27, wherein the social currency is exchanged for admission to a private event.

31. The social network recited in claim 27, wherein a first amount of the social currency correlates to a first player rating and a second amount of the social currency correlates to a second player rating that is higher than the first player rating.

33. The social network recited in claim 1, wherein the memory further comprises a merchandising module containing information relating to merchandise offered for sale.

34. The social network recited in claim 33, wherein the merchandise may be purchased with social currency.

35. A computer-readable medium comprising computer-executable instructions to perform a method, comprising:
identifying a sporting activity;
identifying a venue of the sporting activity;
identifying a first team to participate in the sporting activity, the first team comprising a plurality of first positions;
associating at least a first player with at least one of the first positions;
identifying a second team to participate in the sporting activity, the second team comprising a plurality of second positions; and
associating at least a second player with at least one of the second positions for the second team;
scheduling the sporting activity; and
sending a message containing information about the sporting activity to the first player and the second player.

36. The computer-readable medium recited in claim 35, wherein the sporting event is a tournament.

37. The computer-readable medium recited in claim 35, wherein the sporting event is a game.

38. The computer-readable medium recited in claim 35, further comprising awarding a prize.

39. The computer-readable medium recited in claim 35, further comprising providing statistics for the first player.

40. The computer-readable medium recited in claim 35, further comprising providing statistics for the first team.

41. The computer-readable medium recited in claim 35, further comprising assigning a rating to the first player.

42. The computer-readable medium recited in claim 41, wherein the step of assigning a rating to the first player is based at least in part on a first player's performance in the sporting event.

43. The computer-readable medium recited in claim 35, further comprising awarding a player with a social currency based at least in part on the first player's performance in the sporting event.

44. The computer-readable medium recited in claim 35, further comprising providing feedback about a player.

45. The computer-readable medium recited in claim 35, further comprising providing feedback about a team.

46. The computer-readable medium recited in claim 35, further comprising providing feedback about a venue.

47. The computer-readable medium recited in claim 35, wherein the feedback includes a video and/or image relating to the first player.

48. The computer-readable medium recited in claim 35, wherein the feedback includes a video and/or image relating to the first team.

49. The computer-readable medium recited in claim 35, wherein the feedback includes a video and/or image relating to the venue.

50. The computer-readable medium recited in claim 35, further comprising searching for the first player.

51. The computer-readable medium recited in claim 35, further comprising searching for the sporting event.

52. The computer-readable medium recited in claim 35, further comprising searching for the first team.

53. The computer-readable medium recited in claim 35, further comprising searching for the first player based at least on a first criteria.

54. The computer-readable medium recited in claim 35, further comprising searching for a venue.

55. The computer-readable medium recited in claim 35, further comprising searching for a venue based on at least a first criteria.

56. The computer-readable medium recited in claim 35, further comprising searching for the sporting event based at least on a first criteria.

57. The computer-readable medium recited in claim 35, further comprising searching for the first team based at least on a first criteria.

58. The computer-readable medium recited in claim 35, further comprising providing merchandise for the first player.

59. The computer-readable medium recited in claim 35, further comprising providing a geographic location of the venue.

60. The computer-readable medium recited in claim 59, wherein the geographic location is depicted by an image of the venue on a map.

61. The computer-readable medium recited in claim 59, further comprising providing directions to the venue.

62. The computer-readable medium recited in claim 60, wherein the image of the venue includes a plurality of images that illustrate characteristics of the venue.

63. A method of organizing a team sporting event, comprising:
identifying a sporting activity;
identifying a venue of the sporting activity;
identifying a first team to participate in the sporting activity, the first team comprising a plurality of first positions;
associating at least a first player with at least one of the first positions;
identifying a second team to participate in the sporting activity, the second team comprising a plurality of second positions; and
associating at least a second player with at least one of the second positions for the second team;
scheduling the sporting activity; and
sending a message containing information about the sporting activity to the first player and the second player.

64. The method recited in claim 61, wherein the message is sent over a mobile network.

65. The method recited in claim 61, wherein the message is accessible by a social networking organization.

66. A social network for sporting activities, comprising:
a memory having a plurality of modules, including:
a user profile module for storing user profile information including at least a first user profile and a second user profile;
a sporting activities module for storing information relating to at least one sporting activity;
a messaging module storing information relating to messages from the first user profile and/or the second user profile;
a mobile computing device capable of receiving a first input relating to a first sporting activity, the mobile computing device communicating with at least one of a mobile network and a computer network; and
a processor for configured to evaluate the first input based at least in part on the information stored in at least one of the user profile module, the sporting activities module, and/or the messaging module.

67. The social network recited in claim 66, wherein a message is automatically generated based at least in part on the evaluation of the first input, and wherein the message is sent to a plurality of players participating in a sporting event.

68. The social network recited in claim 67, wherein the message includes information relating to scheduling a sporting activity.

69. The social network recited in claim 66, wherein a message is generated that includes information regarding a communication from a first player to a second player.

70. The social network recited in claim 66, wherein the user profile information, the sporting activities information, and the messaging information are accessible by a social network organization.

71. A social network for sporting activities, comprising:
a memory having a plurality of modules, including:
a user profile module for storing user profile information including at least a first user profile and a second user profile;
a sporting activities module for storing information relating to at least one sporting activity;
a messaging module storing information relating to messages from the first user profile and/or the second user profile;
a mobile computing device capable of receiving a first input relating to a first sporting activity, the mobile computing device communicating with at least one of a mobile network and a computer network; and
a processor for configured to evaluate the first input based at least in part on the information stored in at least one of the user profile module, the sporting activities module, and/or the messaging module, and wherein the processor is also configured to search the user profile information, the sporting activities information, and the messaging information based at least in part on the input.
